(19) United States
(12) Patent Application Publication
(10) Pub. No.: US 2025/0390050 A1
(43) Pub. Date: Dec. 25, 2025

(54) SHEET PROCESSING APPARATUS, IMAGE FORMING APPARATUS, AND IMAGE FORMING SYSTEM

(71) Applicants: Naohiro YOSHIDA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP)

(72) Inventors: Naohiro YOSHIDA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP)

(73) Assignee: Ricoh Company, Ltd., Tokyo (JP)

(21) Appl. No.: 19/216,051

(22) Filed: May 22, 2025

(30) Foreign Application Priority Data
Jun. 24, 2024 (JP) 2024-101579

(51) Int. Cl. G03G 15/00

(52) U.S. Cl. CPC G03G 15/6529; G03G 15/6502; G03G 15/6544; G03G 15/6547; G03G 15/6582

(57) ABSTRACT

A sheet processing apparatus includes an insertion portion, a sheet processing device, and a position marker. The insertion portion has an opening into which a sheet is insertable. The sheet processing device performs a predetermined operation onto the sheet inserted into the insertion portion. The position marker forms a mark at a processing position at which the predetermined operation is to be performed onto the sheet.

### CROSS-REFERENCE TO RELATED APPLICATION

This patent application is based on and claims priority pursuant to 35 U.S.C. § 119 (a) to Japanese Patent Application No. 2024-101579, filed on Jun. 24, 2024, in the Japan Patent Office, the entire disclosure of which is hereby incorporated by reference herein.

### BACKGROUND

### Technical Field

Embodiments of the present disclosure relate to a sheet processing apparatus, an image forming apparatus, and an image forming system.

### Related Art

Various types of sheet processing apparatuses to perform a predetermined process on a sheet medium, image forming apparatuses to form an image on a medium, or image forming systems including a sheet processing apparatus and an image forming apparatus are known. A sheet processing apparatus in the art is known that perform an operation to insert a sheet bundle that the user bundles multiple sheets into an insertion port and bind the sheet bundle.

### SUMMARY

Embodiments of the present disclosure described herein provide a novel sheet processing apparatus including an insertion portion, a sheet processing device, and a position marker. The insertion portion has an opening into which a sheet is insertable. The sheet processing device performs a predetermined operation onto the sheet inserted into the insertion portion. The position marker forms a mark at a processing position at which the predetermined operation is to be performed onto the sheet.

Further, embodiments of the present disclosure described herein provide an image forming apparatus including an image forming device, a sheet stacker, and the above-described sheet processing apparatus. The image forming device forms an image on a sheet. The sheet stacker is a member to which the sheet having the image is ejected. The sheet processing apparatus performs a predetermined operation onto the sheet having the image while contacting the sheet. The sheet processing apparatus includes a sheet processing device, and moves between a first position at which the predetermined operation is performed on the sheet ejected to the sheet stacker and a second position at which the predetermined operation is performed on the sheet having the image before the sheet is ejected to the sheet stacker.

Further, embodiments of the present disclosure described herein provide an image forming system including an image forming apparatus to form an image on a sheet, and the above-described sheet processing apparatus is coupled to the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an image forming apparatus according to a first embodiment of the present disclosure;

FIG. 2 is an external view of a sheet processing apparatus according to the first embodiment of the present disclosure;

FIG. 3 is a plan view of a sheet binder included in the sheet processing apparatus according to the first embodiment of the present disclosure;

FIGS. 4A and 4B are diagrams illustrating a binding processing position in the sheet processing apparatus;

FIG. 5 is a block diagram of a controller included in the sheet processing apparatus;

FIGS. 6A and 6B are diagrams illustrating a first example of a processing position marking mechanism included in the sheet processing apparatus;

FIG. 7 is a perspective view of the first example of the processing position marking mechanism;

FIGS. 8A, 8B, 8C, 8D and 8E are diagrams illustrating a manual binding operation according to the first example;

FIGS. 9A and 9B are diagrams illustrating marks of the sheet binding positions according to the first example and a sheet bundle after the sheet binding operation;

FIG. 10 is an enlarged view of an example of a projection of the processing position marking mechanism according to the first example;

FIG. 11 is an enlarged view of another example of a projection of the processing position marking mechanism according to the first example;

FIGS. 12A, 12B and 12C are diagrams illustrating a second example of a processing position marking mechanism included in the sheet processing apparatus;

FIGS. 13A and 13B are diagrams illustrating a third example of a processing position marking mechanism included in the sheet processing apparatus;

FIGS. 14A, 14B, 14C, 14D and 14E are diagrams illustrating a manual binding operation according to the third example;

FIGS. 15A and 15B are diagrams illustrating a fourth example of a processing position marking mechanism included in the sheet processing apparatus;

FIG. 16 is a perspective view of the fourth example of the processing position marking mechanism;

FIGS. 17A, 17B, 17C and 17D are diagrams illustrating a manual binding operation according to the fourth example;

FIGS. 18A and 18B are diagrams illustrating a fifth example of a processing position marking mechanism included in the sheet processing apparatus;

FIGS. 19A, 19B and 19C are diagrams illustrating a manual binding operation according to the fifth example;

FIGS. 20A, 20B and 20C are diagrams illustrating a manual binding operation according to a sixth example of a processing position marking mechanism included in the sheet processing apparatus;

FIG. 21 is a diagram illustrating an example of display of an operation display unit included in a sheet binder according to the first embodiment;

FIG. 22 is a flowchart of a first example of a processing position marking operation executable by the sheet binder;

FIG. 23 is a flowchart of a second example of a processing position marking operation executable by the sheet binder;

FIG. 24 is a plan view of a sheet binder according to a second embodiment;

FIGS. 25A, 25B and 25C are diagrams illustrating an example of display on an operation display unit included in a sheet binder according to a third embodiment;

FIG. 26 is a plan view of a sheet binder according to a fourth embodiment;

FIGS. 27A, 27B and 27C are diagrams illustrating a seventh example of a processing position marking mechanism included in the sheet processing apparatus;

FIGS. 28A, 28B, 28C and 28D are diagrams illustrating a manual binding operation according to the seventh example;

FIGS. 29A and 29B are plan views of a sheet binder according to a fifth embodiment;

FIG. 30 is a flowchart of control processing performed by the sheet binder according to the fifth embodiment;

FIG. 31 is an external view of an image forming apparatus according to a second embodiment of the present disclosure;

FIG. 32A is a diagram illustrating a control configuration of an image forming apparatus according to the second embodiment of the present disclosure;

FIG. 32B is a diagram illustrating an example of a functional block of the image forming apparatus of FIG. 32A;

FIG. 33A is a diagram illustrating another control configuration of an image forming apparatus according to the second embodiment of the present disclosure;

FIG. 33B is a diagram illustrating an example of a functional block of the image forming apparatus of FIG. 33A;

FIG. 34 is a diagram illustrating a hardware configuration of an image forming apparatus according to the second embodiment;

FIG. 35 is a diagram illustrating a configuration of a conveyance path of a sheet binder;

FIG. 36 is a diagram illustrating a conveyance process of a sheet binder;

FIG. 37 is a diagram illustrating a conveyance process of the sheet binder, subsequent to the conveyance process of FIG. 36;

FIG. 38 is a diagram illustrating a conveyance process of the sheet binder;

FIG. 39 is a diagram illustrating a conveyance process of the sheet binder, subsequent to the conveyance process of FIG. 38;

FIG. 40 is an external view of a sheet processing apparatus according to a sixth embodiment of the present disclosure;

FIG. 41 is a diagram illustrating an example of a configuration of an image forming system according to the present disclosure;

FIG. 42 is a diagram illustrating another example of a configuration of an image forming system according to the present disclosure; and

FIG. 43 is a diagram illustrating yet another example of a configuration of an image forming system according to the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. In the drawings, the same or corresponding parts are denoted by the same reference numerals, and redundant description thereof are simplified or omitted as appropriate.

Embodiments of the present disclosure are described below with reference to the drawings. The same reference numerals are given to identical or corresponding constituent elements such as parts and members having the same reference numerals, and redundant descriptions thereof are omitted unless otherwise required.

### First Embodiment of Image Forming Apparatus

A description is given of an image forming apparatus according to a first embodiment of the present disclosure.

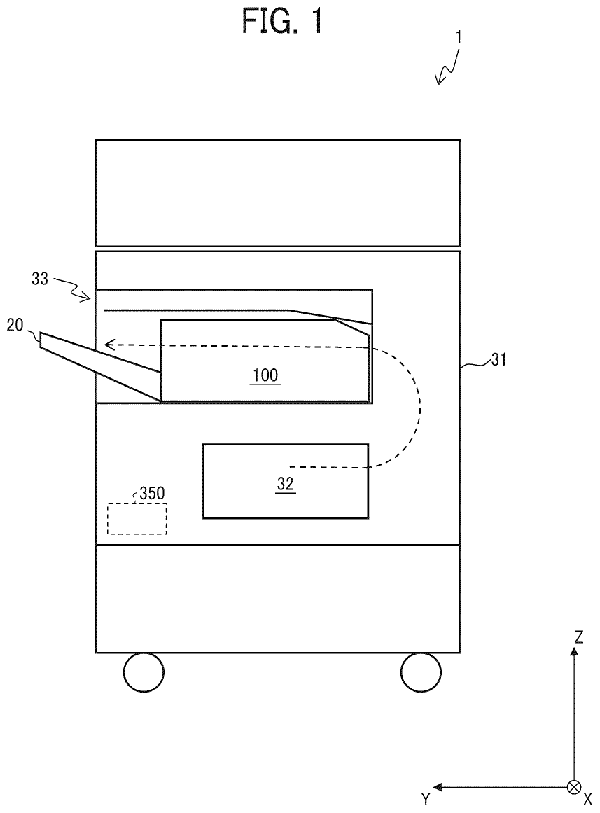

FIG. 1 is an external view of an image forming apparatus 1 according to a first embodiment of the present disclosure.

More specifically, FIG. 1 is a diagram illustrating an example of an image forming apparatus 1 having an in-body portion and including a sheet binder 100 as an embodiment of a sheet processing apparatus according to the present disclosure.

A sheet medium that is an object to be processed can be assumed to be various types of media, and is employed as a sheet in the following description. A sheet medium that is an object to be processed in the description below is referred to as a “sheet S”. Further, as an example of the post-processing, a sheet binding operation of binding a sheet bundle Sb in which multiple sheets S are stacked will be mainly described.

A predetermined process or operation executed by the sheet processing apparatus corresponds to a process or operation that is executed after an image forming operation, which may be referred to as a “post-processing operation”. The predetermined process is referred to as a “post-processing operation” below.

There are multiple types of post-processing operations. For example, multiple types of post-processing operations include an alignment operation to align one end of multiple sheets, a sheet binding operation to bind a sheet bundle made of stacking the multiple sheets, and a sheet folding operation to fold the sheets to a given shape (e.g., a Z-fold, a letter fold-out, or a half-fold).

The sheet binding operation that is one of the post-processing includes, for example, a “stapling process” for penetrating, for example, a metallic needle or needles through a sheet bundle to bind the sheet bundle, and a “crimping process” for performing pressure deformation on an end portion of a sheet bundle to bind the sheet bundle without stapling the sheet bundle with the needle or needles. Further, some single sheet processing apparatuses in the art include a binding unit (stapler) to perform a binding with needles and a binding unit (crimper) to perform a crimp binding, separately.

The sheet binder 100 illustrated in FIG. 1 is provided in an in-body space 33 formed in a part of a housing 31 of the image forming apparatus 1. The sheet binder 100 has a function of performing a “sheet binding operation” as a predetermined process (post-processing operation) on a sheet S as a sheet medium on which an image is formed by an image forming device 32. The sheet binder 100 may have a function of performing an automatic sheet binding operation in which multiple sheets S on which images are formed are aligned inside the sheet binder 100, an end of a sheet bundle Sb that is obtained by bundling the sheets S is bound, and the sheet bundle Sb is ejected to an ejection tray 20 as a sheet stacker; and a function of performing a manual binding operation in which a user binds an end of the sheet bundle Sb of multiple sheets S after the sheets S on which images are formed are ejected to the ejection tray 20.

In the present embodiment, the sheet binder 100 is assumed to be installed in the body (the in-body space 33) of the image forming apparatus 1, but is not limited to the above-described sheet binder 100, and may be installed on a lateral side face of the housing 31 of the image forming apparatus 1 or may be operable independently of the image forming apparatus 1.

### First Embodiment of Sheet Processing Apparatus

A description is given below of the sheet processing apparatus according to a first embodiment of the present disclosure.

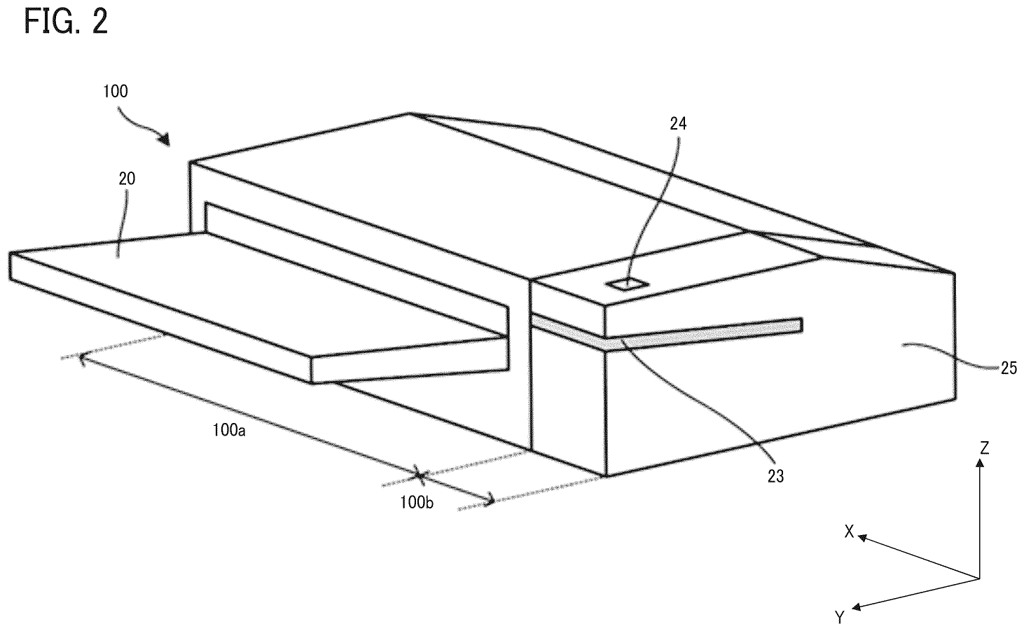

FIG. 2 is a perspective view (external view) of the sheet binder 100 as a sheet processing apparatus according to an embodiment of the present disclosure.

The sheet binder 100 is, for example, a device that performs a sheet binding operation that is an example of a post-processing process of the image forming operation. The sheet binder 100 includes a main body 100m and a manual binder part 100h. The main body 100m is a part where the sheet binder 100 automatically performs the sheet binding operation on the sheet S as a sheet medium ejected from the image forming apparatus 1. The manual binder part 100h is a part where the user manually perform the sheet binding operation using the sheet S ejected to the ejection tray 20.

The binding unit to execute the sheet binding operation as a sheet processing device includes a stapler 19 to perform a sheet stapling operation and a crimp binder 26 to perform a crimp binding operation, which will be described below. In the following description, the binding unit may be referred to as a “binding unit” when the type of the sheet binding operation is not considered.

As illustrated in FIG. 2, the sheet binder 100 includes an exterior cover 25 that is a part corresponding to the manual binder part 100h, and a slit 23 that is formed in a part of the exterior cover 25. The slit 23 is a portion through which the sheet S and the sheet bundle Sb can be inserted. The slit 23 is a gap in a part of the exterior cover 25, and has a depth corresponding to the depth of the manual binder part 100h. The slit 23 is a part of an insertion portion.

The slit 23 is disposed to have an inclination by a given angle in the horizontal direction so that the sheet S is placed on the same plane with the ejection tray 20. The state of the slit 23 is not limited to the above-described state, and the slit 23 may be disposed horizontally. The relative positions of the ejection tray 20 and the slit 23 are not particularly limited, provided that the relative positions allow the binding unit to perform any one of the sheet binding operation in the main body 100m and the sheet binding operation in the manual binder part 100h.

A manual binding operation is started when the user presses a start button 24 illustrated in FIG. 2. The start button 24 is mounted on the exterior cover 25. As the start button 24 is pressed, the sheet binding operation on the sheet S or the sheet bundle Sb inserted in the slit 23 or the processing position marking operation is performed. The position at which the binding unit performs the sheet binding operation may be a home position (HP) of the binding unit when performing the manual binding operation.

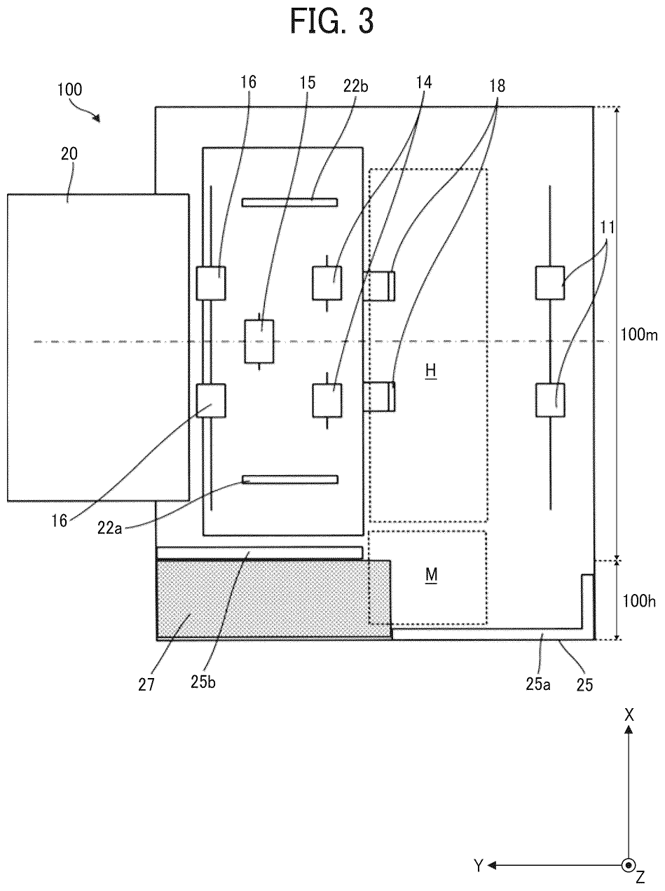

FIG. 3 is a plan view of the sheet binder 100.

The dot-dashed line in FIG. 3 indicates the reference position that is the center in the width direction of the sheet S that is conveyed and ejected in the main body 100m.

In FIG. 3, an example of a position (a main body processing position) at which the binding unit is disposed at the time of the sheet binding operation in the main body 100m is indicated by “H”, and an example of a position (a manual processing position) at which the binding unit is disposed at the time of the sheet binding operation in the manual binder part 100h is indicated by “M”.

As illustrated in FIG. 3, the exterior cover 25 of the manual binder part 100h includes a stopper 25a and a stopper 25b. The stopper 25a restricts the edge in the Y direction that is one end side of the sheet S that is manually inserted in the slit 23. The stopper 25b restricts the edge in the X direction that is another end side of the sheet S. The edge in the X direction and the edge in the Y direction correspond to adjacent two end sides, and are orthogonal to each other. In other words, the stopper 25a and the stopper 25b as aligners are disposed orthogonal to each other.

When the sheet S or the sheet bundle Sb is manually inserted into the slit 23, the leading end of the sheet S or the sheet bundle Sb near the binding unit in the X direction is stopped by the stopper 25a, and the leading end of the sheet S or the sheet bundle Sb near the interior of the sheet binder in the Y direction is stopped by the stopper 25b. Due to such a configuration, the sheet S or the sheet bundle Sb inserted in the slit 23 is positioned inside the slit 23. Due to this positioning, the portion where the sheet binding operation is performed on the sheet S or the sheet bundle Sb corresponds to the position where the sheet binding operation can be performed by the binding unit.

The sheet binder 100 according to the present embodiment has two or more processing modes.

For example, the sheet binder 100 has an automatic processing mode and a manual processing mode.

The automatic processing mode is a processing mode in which the sheet binding operation is performed on the sheet S in the main body 100m. The manual processing mode is a processing mode in which the sheet binding operation is performed on the sheet S in the manual binder part 100h.

The main body 100m allows the binding unit to perform the sheet ejecting operation in which the sheet S that is conveyed by a conveyor is ejected without performing the post-processing operation on the sheet S. Further, the manual binder part 100h allows the binding unit to perform a manual processing operation (manual binding operation) in which the post-processing operation is performed on the sheet S that is inserted in the slit 23. The sheet ejecting operation to eject the sheet S without performing the post-processing operation on the sheet S includes a shift sheet ejecting operation. The sheet ejecting operation or the shift sheet ejecting operation can be started during the manual processing operation. Similarly, the manual processing operation can be started during the sheet ejecting operation or the shift sheet ejecting operation. The operations of the sheet binder 100 will be described below.

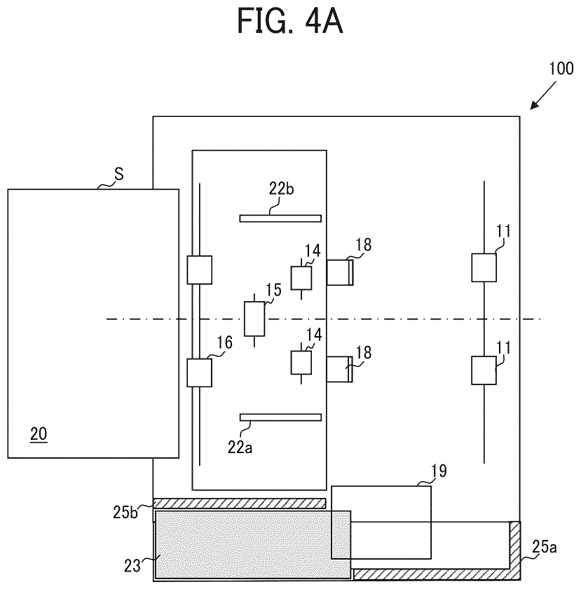

FIGS. 4A and 4B are diagrams illustrating a binding processing position in the sheet binder 100 as a sheet processing apparatus.

As illustrated in FIG. 4A, the sheet binder 100 includes, for example, the stapler 19 that performs a stapling operation. The sheet binder 100 may include not only the stapler 19 but another unit. As illustrated in FIG. 4B, the sheet binder 100 may include the stapler 19 and a crimp binder 26. The stapler 19 and the crimp binder 26 may be disposed at the above-described main body processing position or the manual processing position.

The manual binding operation is started when the user presses the start button 24 (see FIG. 2). The position at which the stapler 19 illustrated in FIGS. 4A and 4B performs the sheet binding operation may be a home position (HP) of the binding unit when performing the manual binding operation. For example, the position of the stapler 19 illustrated in FIG. 4A may be the home position.

As illustrated in FIG. 4A, the sheet binder 100 may use the stapler 19 as a first processing unit to perform the sheet binding operation on the sheet S ejected to the ejection tray 20 or the stapler 19 as a second processing unit to perform the sheet binding operation on the sheet S before the sheet S on which the image is formed is ejected to the ejection tray 20. Further, as illustrated in FIG. 4B, in a case where the sheet binder 100 includes both the stapler 19 and the crimp binder 26, one of the stapler 19 and the crimp binder 26 may be a first processing unit and the other of the stapler 19 and the crimp binder 26 may be a second processing unit.

### Configuration of Control Block of Sheet Binder 100

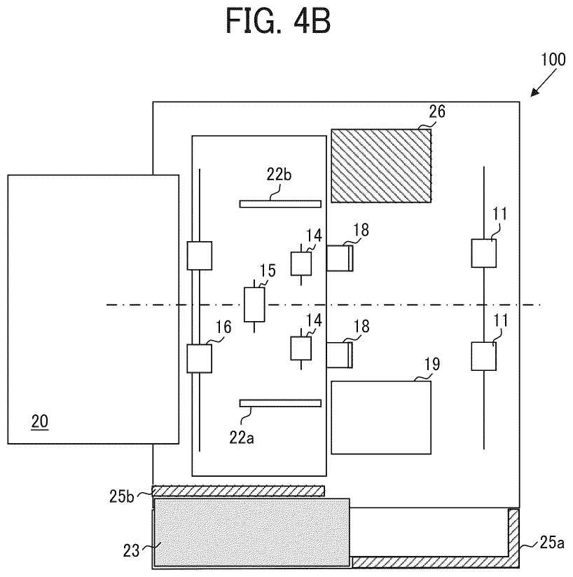

A description is given of the configuration of the control block of the sheet binder 100, with reference to FIG. 5.

FIG. 5 is a block diagram illustrating a hardware configuration for executing control processing in the sheet binder 100.

As illustrated in FIG. 5, the sheet binder 100 includes a central processing unit (CPU) 151, a random access memory (RAM) 152, a read only memory (ROM) 153, a hard disk drive (HDD) 154, and an interface (I/F) 155. The CPU 151, the RAM 152, the ROM 153, the HDD 154, and the I/F 155 are connected to each other via a common bus 159.

The CPU 151 is an arithmetic device and controls the overall operation of the sheet binder 100. The RAM 152 is a volatile storage medium that allows data to be read and written at high speed. The CPU 151 uses the RAM 152 as a work area for data processing. The ROM 153 is a read-only non-volatile storage medium that stores programs such as firmware. The HDD 154 is a non-volatile storage medium that allows data to be read and written and has a relatively large storage capacity. The HDD 154 stores, for example, an operating system (OS), various control programs, and application programs.

By an arithmetic function of the CPU 151, the sheet binder 100 processes, for example, a control program stored in the ROM 153 and an information processing program (application program) loaded into the RAM 152 from a storage medium such as the HDD 154. Such processing configures a software controller including various functional modules of the sheet binder 100. The software controller thus configured cooperates with hardware resources of the sheet binder 100 to construct functional blocks that implement functions of the sheet binder 100. In other words, the CPU 151, the RAM 152, the ROM 153, the HDD 154, and the I/F 155 constitute a controller 150 (a control unit) that controls the operation of the sheet binder 100.

The I/F 155 is an interface that connects at least a sheet binder movement motor 191, a sheet binder drive motor 192, a pressing member sensor 193, and a sheet detection sensor 194 to the common bus 159. The sheet binder movement motor 191 includes a driving mechanism to move the position of the stapler 19. The sheet binder drive motor 192 includes a drive source for the sheet binding operation of the stapler 19. The pressing member sensor 193 detects the operation of a pressing member 54, which will be described below. The sheet detection sensor 194 detects that the sheet bundle Sb is inserted in the slit 23 and is located at the sheet binding position.

The controller 150 controls the operations of the sheet binder movement motor 191 and the sheet binder drive motor 192 via the I/F 155. Further, the controller 150 acquires the detection result of the pressing member sensor 193 and determines the position of the pressing member 54 based on the detection result. Further, the controller 150 acquires the detection result of the sheet detection sensor 194 and controls whether the manual binding operation is performed based on the detection result.

The controller 150 is connected to an image forming apparatus controller 350 of the image forming apparatus 1 to communication with each other. Due to such a configuration, the image forming apparatus controller 350 sends the setting information and information indicating the process contents to the sheet binder 100 so that the sheet binder 100 performs the operation appropriate to the process contents set in the image forming apparatus 1. Further, information related to the process operation performed in the sheet binder 100 is sent to the image forming apparatus controller 350 via the I/F 155. The image forming apparatus controller 350 controls the operations of various components of the image forming apparatus 1.

As described above, the sheet binder 100 implements the function of performing operation control related to the liquid application by software (control programs) executed by the CPU 151 with hardware resources included in the controller 150.

### Embodiment of Processing Position Marking Mechanism

A description is given of a processing position marking mechanism 50 included in the sheet binder 100 according to the present embodiment, with reference to the drawings.

The processing position marking mechanism 50 according to the present embodiment is an example of a structure having a function of indicating the position at which the sheet bundle Sb is bound, in other words, the position of the sheet bundle Sb on which the sheet binding operation is performed, before the sheet binding operation, when the sheet binding operation is performed in the manual binding mode. In other words, the processing position marking mechanism 50 is an example of a structure having a function of making the position at which the sheet binding operation is performed be visibly recognizable, before the sheet binding operation is performed.

### First Example of Processing Position Marking Mechanism 50

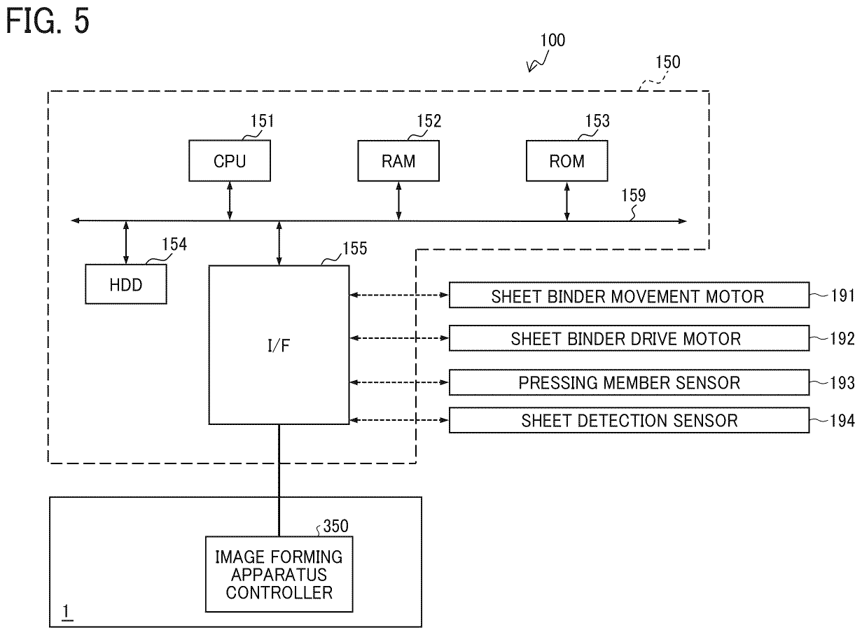

FIGS. 6A and 6B are diagrams illustrating the processing position marking mechanism 50 according to a first example.

As illustrated in FIGS. 6A and 6B, the processing position marking mechanism 50 according to the first example includes at least a driver 51, a staple holder 52, a clincher 53, a pressing member 54 corresponding to a position marker, and a spring 55.

The driver 51 is a member for pressing and pushing out the staple 529 stored in the staple holder 52 toward the sheet bundle Sb as an object on which the sheet binding operation is performed, and causing the staple 529 to penetrate the sheet bundle Sb to bind the sheet bundle Sb. The driver 51 is a member that is fixed to a part of the exterior cover 25 and is movable by a mechanism that moves down toward the sheet bundle Sb inserted in the slit 23 when the sheet binding operation is performed.

The staple holder 52 stores the staple 529 as a binding member to penetrate and bind the sheet bundle Sb.

Further, the staple holder 52 has projections 521 in a part of the outer side facing the sheet S. The projections 521 are disposed at the positions separated from each other to face each other in the longitudinal direction of the staple 529. In other words, the projections 521 are two projections away from each other in the straight line in the longitudinal direction of the staple 529 and disposed on the opposite side of the staple 529. The staple holder 52 is pressed by the pressing member 54 to move in a direction to approach the sheet bundle Sb. The staple 529 is pressed by the driver 51 to move in a direction approaching the sheet bundle Sb and penetrate the sheet bundle Sb.

The clincher 53 is a guide to receive and bend the staple 529 to bind the sheet bundle Sb when the staple 529 stored in the staple holder 52 is pressed by the driver 51 and penetrates the sheet bundle Sb. The clincher 53 has staple binding parts 532 where the tip portions of the staple 529 pressed by the driver 51 are bent so that the sheet bundle Sb is nipped between the tip portions of the staple 529 and the longitudinal part of the staple 529. Further, the clincher 53 has recesses 531 at the positions facing the projections 521 of the staple holder 52.

The recesses 531 approach the sheet bundle Sb as the pressing member 54 presses the staple holder 52. When the projections 521 contact and are further pressed against the sheet bundle Sb, the recesses 531 receive the parts of the sheet bundle Sb deformed by the projections 521.

The pressing member 54 is supported by the spring 55 so as to be above the staple holder 52. As the driver 51 moves downward to approach the sheet bundle Sb for the sheet binding operation, the pressing member 54 descends with the driver 51 at the same time as the spring 55 moves.

Further, the pressing member 54 descends as the driver 51 moves downward, and contacts the staple holder 52. As the driver 51 further moves downward with the pressing member 54 continuously in contact with the staple holder 52, the staple holder 52 reaches the uppermost face of the sheet bundle Sb before the driver 51 reaches the uppermost face of the sheet bundle Sb.

As the driver 51 further moves downward with the staple holder 52 continuously in contact with the sheet bundle Sb, the pressing member 54 presses the staple holder 52 due to the biasing force of the spring 55. As a result, the projections 521 of the staple holder 52 press the sheet bundle Sb. The projections 521 press the given positions (the sheet binding position) on the uppermost sheet S of the sheet bundle Sb, a recess as a mark of the sheet binding position is formed at each of the given positions.

The spring 55 supports the pressing member 54 at a position where the pressing member 54 does not contact the driver 51, and biases the pressing member 54 in a direction to approach the sheet bundle Sb.

FIG. 6B is a side view of the processing position marking mechanism 50 according to the first example.

As illustrated in FIG. 6B, the driver 51 is located immediately above the staple 529 stored in the staple holder 52. The pressing member 54 is supported at a position where the pressing member 54 does not contact the driver 51, and is supported by the spring 55 whose one end is fixed to a portion corresponding to the position at the same height as the driver 51. Therefore, after the driver 51 moves in the direction approaching the sheet bundle Sb and comes into contact with the staple holder 52, the biasing force of the spring 55 is applied to the staple holder 52 according to the movement of the driver 51, and the staple holder 52 is pressed toward the sheet bundle Sb.

As the staple holder 52 is pressed toward the sheet bundle Sb, the projections 521 are pressed against the sheet bundle Sb, and thus the mark of the sheet binding position is applied to the uppermost sheet S of the sheet bundle Sb. In other words, the staple holder 52 and the pressing member 54 constitute a mechanism for providing a mark with respect to each position (processing position) of the sheet bundle Sb on which the sheet binding operation is performed by the staple 529. The staple holder 52 and the pressing member 54 correspond to a position marker that allows the user to visually recognize the processing position at which the sheet binding operation is performed, before the sheet binding operation. In order to make the processing position visible to the user, the projections 521 of the staple holder 52 may be pressed against the sheet bundle Sb to form two pressing marks formed of recessed portions (recesses) so as to sandwich the processing position. The pressing marks are formed at positions corresponding to the outer sides of the end portions on the opposite sides in the longitudinal direction of the staple 529.

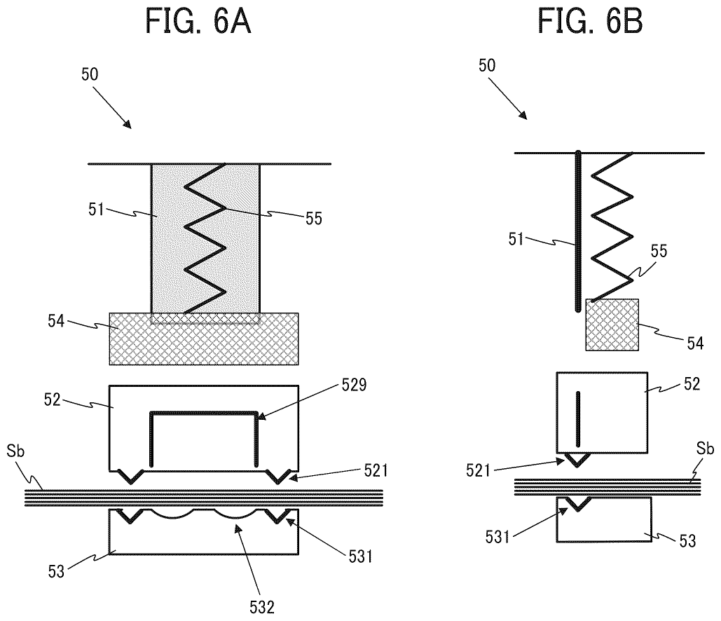

FIG. 7 is a perspective view of the processing position marking mechanism 50 according to the first example, illustrating the relative positions of the driver 51 and the pressing member 54.

In FIG. 7, the staple holder 52 and the clincher 53 are omitted. As illustrated in FIG. 7, the staple 529 is located at a position corresponding to the sheet binding position for binding the sheet bundle Sb, and the position where the sheet binding operation is performed corresponds to the vicinity of the outer edge of the sheet bundle Sb. The driver 51 is disposed at a position where the driver 51 can press the staple 529 upward in the vicinity of the outer edge.

The pressing member 54 is disposed at a position where the pressing member 54 does not hinder the movement of the driver 51 when the driver 51 pushes out the staple 529. Further, the pressing member 54 is disposed at a position where an operation is performed to apply a mark indicating a position where the staple 529 penetrates the sheet bundle Sb. For example, the pressing member 54 is disposed at a position corresponding to the outside of the outer edge of the sheet bundle Sb where the driver 51 is disposed, and is supported at the position where the staple holder 52 can be pressed.

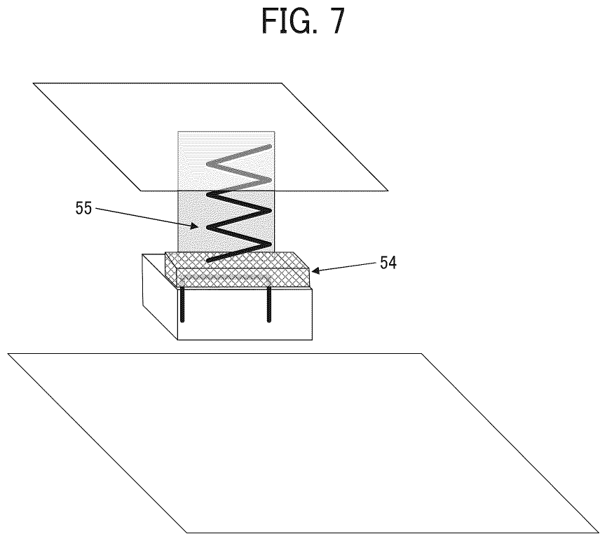

A description is given of a manual binding operation according to the first example, with reference to FIGS. 8A, 8B, 8C, 8D and 8E.

FIGS. 8A, 8B, 8C, 8D and 8E are diagrams illustrating a manual binding operation according to the first example. Specifically, FIG. 8A illustrates a state in which the driver 51 and the pressing member 54 are at the home position that is the sheet binding position before the sheet binding operation is started. As illustrated in FIG. 8B, at the same time when the driver 51 moves downward, the pressing member 54 that is supported via the spring 55 descends.

Even when the driver 51 moves downward to a certain position, the driver 51 does not come into contact with the staple 529. However, when the staple holder 52 contacts the sheet bundle Sb to be pressed against the sheet bundle Sb, the projections 521, which are stored in the staple holder 52 that is pressed by the pressing member 54, form the recesses as marks on the sheet bundle Sb.

Subsequently, as illustrated in FIG. 8C, after the projections 521 are sufficiently pushed into the sheet bundle Sb and the sheet bundle Sb is deformed, the spring 55 is contracted, and thus the staple holder 52 stops moving downward. However, the driver 51 continues to move downward. At this time, when the driver 51 stops moving downward before contacting the staple 529, the driver 51 moves upward once, and the sheet bundle Sb is taken out from the sheet binder 100. As a result, the user can visually recognize the mark indicating the position (processing position) at which the sheet binding operation is to be performed.

As the driver 51 is continuously lowered from the state of FIG. 8C to the state of FIG. 8D, the staple 529 is pressed down and penetrates the sheet bundle Sb, and then the sheet binding operation as illustrated in FIG. 8E is performed.

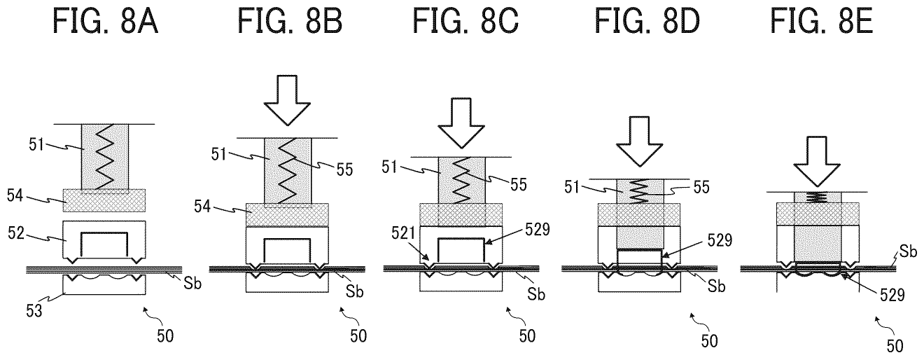

FIGS. 9A and 9B are diagrams each illustrating an example of application of a mark of the sheet binding position.

FIG. 9A illustrates an example of the state of marks as illustrated in FIG. 8C, in other words, an example of the state of marks that are applied when the projections 521 are sufficiently pushed into the sheet bundle Sb and the sheet bundle Sb is deformed. The driver 51 is moved upward at the deformation of the sheet bundle Sb by the projections 521 and the sheet bundle Sb is taken out from the slit 23 before the sheet binding operation is performed. By so doing, marks 5211 as marks or indication illustrated in FIG. 9A can be visually recognized by the user.

More specifically, when the driver 51 stops descending with the projections 521 deforming the sheet bundle Sb, the projections 521 of the staple holder 52 is in contact with the uppermost sheet S of the sheet bundle Sb by the pressing member 54. From the contact state, as the driver 51 is moved upward, the pressing member 54 also rises and the pressing of the staple holder 52 onto the sheet bundle Sb is released. As a result, the sheet bundle Sb with the marks 5211 can be visually recognized. The staple holder 52 has a function of rising to the position to be separated from the sheet bundle Sb when the pressing of the pressing member 54 is released.

FIG. 9B illustrates a state in which the driver 51 is moved downward to the state illustrated in FIG. 8E to perform the sheet binding operation, and then the sheet bundle Sb is taken out from the slit 23.

As illustrated in FIGS. 9A and 9B, as a mark indicating each position at which the staple 529 binds the sheet bundle Sb, the marks 5211 are provided on the opposite sides of the sheet binding position of the staple 529. Further, in the example of FIG. 9B, the marks 5211 are located on the left and right sides of the extension of the virtual straight line that extends along the staple 529 and overlaps the staple 529.

Accordingly, the driver 51 descends to the state illustrated in FIG. 8C, temporarily stops, and then ascends to take the sheet bundle Sb out from the slit 23. By so doing, the user can visually recognize the marks illustrated in FIG. 9A, so as to confirm the sheet binding position in advance. More specifically, the user can recognize that the staple 529 is to be used for binding on a virtual straight line that is inside the marks 5211 on the left and right sides and connects the marks 5211. Subsequently, the sheet bundle Sb is inserted into the slit 23 and the driver 51 is moved downward to the state illustrated in FIG. 8E to perform the sheet binding operation. By so doing, as illustrated in FIG. 9B, the sheet binding operation can be performed at the position confirmed with the marks or indication (the marks 5211).

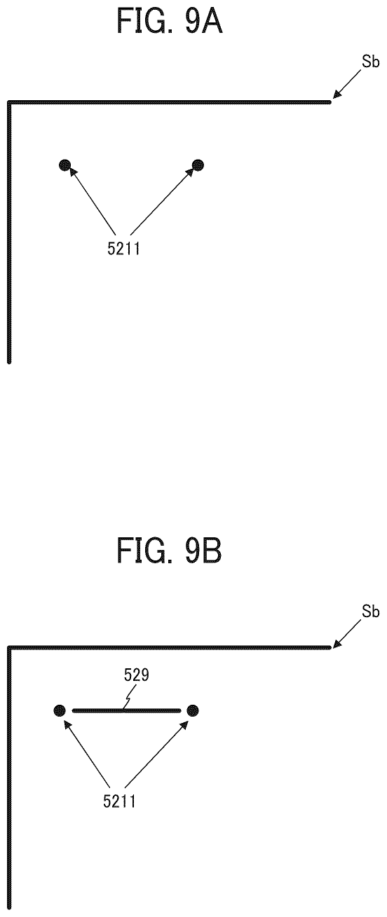

FIG. 10 is an enlarged view of the projections 521 on the staple holder 52.

As illustrated in FIG. 10, each of the projections 521 has a shape in which a minute recess is formed in a part of the sheet bundle Sb as marks for making the processing position (sheet binding position) visible to the user. The projections 521 correspond to sharp protruding portions that can bite into the sheet bundle Sb.

The tip portion of each of the projections 521 desirably has an acute angle. The angle is preferably, for example, 45 degrees or less, and more preferably about 30 degrees. The amount of protrusion of each of the projections 521 is preferably equal to or greater than 1 mm.

In FIG. 10, the amount of projection is illustrated as 3 mm. Accordingly, the marks of the processing position can be applied to the sheet bundle Sb even with a small pressing force.

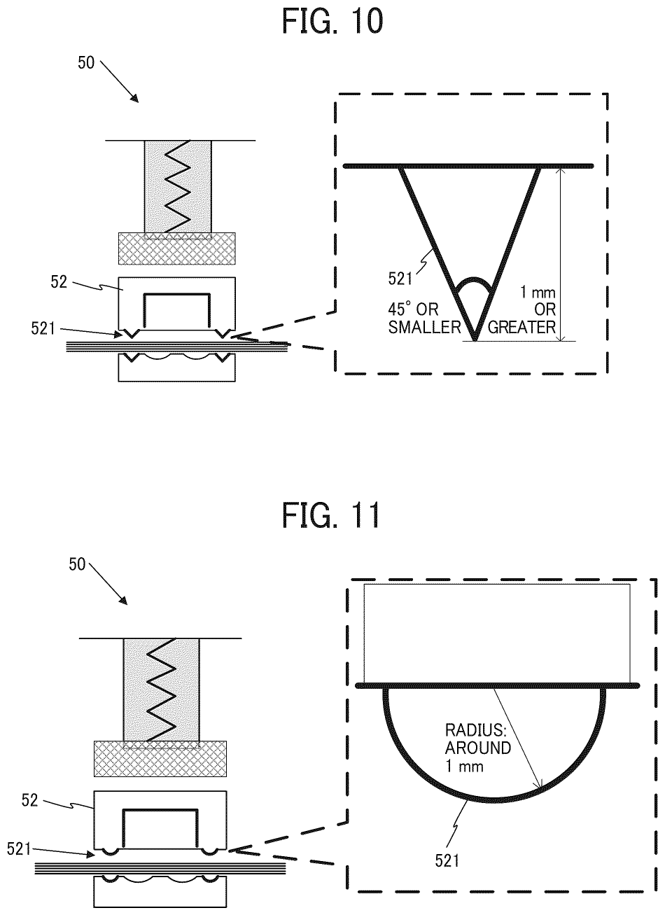

The shape of the tip portion of each of the projections 521 is not limited to the shape illustrated in FIG. 10. FIG. 11 is an enlarged view of another example of a projection of the processing position marking mechanism according to the first example. For example, the tip portion of each of the projections 521 may have an arc shape as illustrated in FIG. 11. In the case of the projections 521 having the arc shape illustrated in FIG. 11, the projection 521 is formed as a portion that does not bite into the sheet bundle but gives a pressing mark on the sheet bundle. In this case, since the size of the tip portion of each of the projections 521 is a hemisphere with a radius of about 1 mm, a mark for clearly indicating the processing position can be attached by slightly deforming a part of the sheet bundle Sb without tearing the part of the sheet bundle Sb and without applying, for example, ink to the sheet bundle Sb.

### Second Example of Processing Position Marking Mechanism 50

A description is given below of a second example of a processing position marking mechanism 50 included in the sheet binder 100 according to the present embodiment.

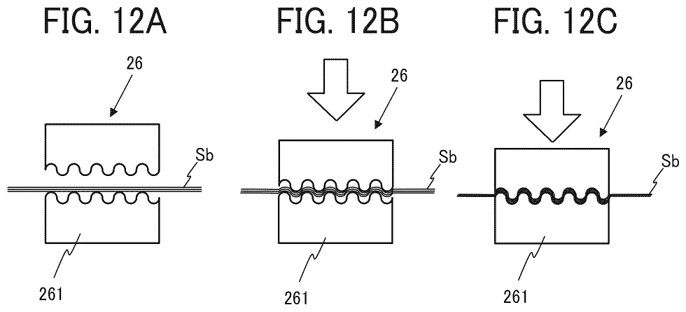

FIGS. 12A, 12B and 12C are diagrams illustrating a schematic configuration of the processing position marking mechanism 50 according to the present example.

The stapler 19 according to the first example is required to include the configuration of the projections 521 to indicate the processing position. In the case of the second example, for example, as illustrated in FIGS. 12A, 12B and 12C, the crimp binding operation on the sheet bundle Sb is performed halfway by using the crimping teeth 261 included in the crimp binder 26, so that the marks indicating the sheet binding position can be applied.

As illustrated in FIG. 12A, the sheet bundle Sb is inserted between the crimping teeth 261. Then, the movement of the crimping teeth 261 is stopped in the middle of the pressing and crimping of the sheet bundle Sb as illustrated in FIG. 12B. When the position of the crimping teeth 261 is returned from this state to the home position illustrated in FIG. 12A, a mark for clearly indicating the processing position can be applied before the sheet binding operation is performed. In this state, when the sheet bundle Sb is taken out from the slit 23, the sheet binding position can be confirmed in advance. According to the present embodiment, the user can recognize that the position of the shape itself formed on the sheet by the crimping teeth 261 is the sheet binding position.

As illustrated in FIG. 12C, the crimp binder 26 can performed the sheet binding operation by nipping and pressing the sheet bundle Sb to entangle the fibers of the multiple sheets S.

### Third Example of Processing Position Marking Mechanism 50

A description is given below of a third example of a processing position marking mechanism 50 included in the sheet binder 100 according to the present embodiment.

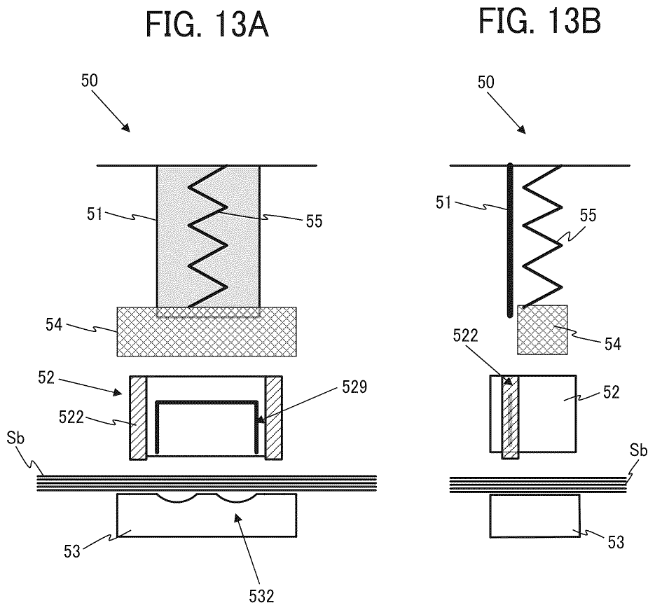

FIGS. 13A and 13B are diagrams illustrating a schematic configuration of the processing position marking mechanism 50 according to the present example.

In the first example, a part of the sheet bundle Sb is deformed by the projections 521 and the recesses 531 to indicate the position (processing position) of the sheet binding operation.

As illustrated in FIGS. 13A and 13B, in the third example, the staple holder 52 includes a first stamp 522 instead of the projections 521 and the recesses 531.

FIG. 13A is a front view of the processing position marking mechanism 50 according to the present example. FIG. 13B is a side view of the processing position marking mechanism 50 according to the present example.

The first stamps 522 are fixed to the outer edge of the staple holder 52 and moves together with the movement of the staple holder 52. Accordingly, the first stamps 522 move downward when the staple holder 52 descends. Further, the first stamps 522 transfer a material such as liquid ink for the marks onto the uppermost sheet S of the sheet bundle Sb when the first stamps 522 come into contact with the sheet bundle Sb. With the material for the marks, the position of the sheet binding operation can be transferred onto the uppermost sheet S of the sheet bundle Sb. The first stamps 522 are disposed on the opposite sides of the staple 529. The staple 529 is located on the virtual straight line connecting the lower ends of the first stamps 522.

Similarly to the first example, the staple holder 52 according to the third example is disposed at a position that is pressed by the pressing member 54. The pressing member 54 is supported by the spring 55 whose one end is fixed. The pressing member 54 is a separated member from the driver 51 that pushes out the staple 529 that is stored in the staple holder 52. The one end of the spring 55 that is fixed is supported by the driver 51. Alternatively, the pressing member 54 is supported by the other end of the spring 55. As the driver 51 moves for the sheet binding operation, the one end of the spring 55 also descends together with the movement of the driver 51.

Along with the above movement of the driver 51, the pressing member 54 also moves at the same time in the same direction.

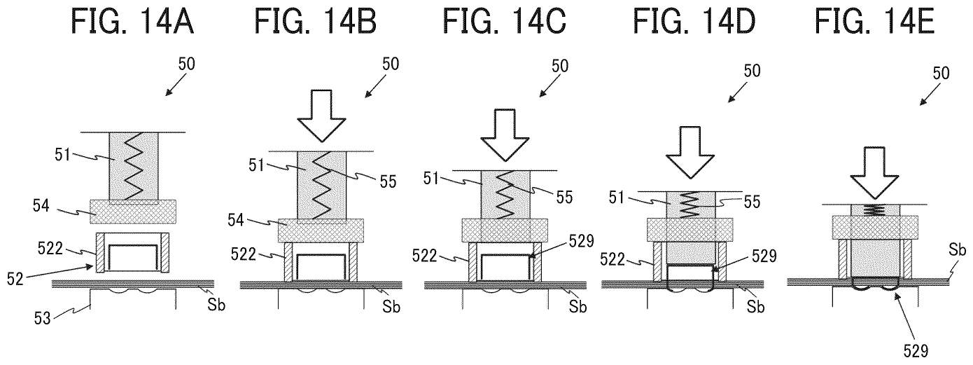

A description is given of the manual binding operation according to the third example, with reference to FIGS. 14A, 14B, 14C, 14D and 14E.

FIGS. 14A, 14B, 14C, 14D and 14E are diagrams illustrating a manual binding operation according to the third example.

FIG. 14A illustrates a state where the driver 51 and the pressing member 54 are at the home position that is the sheet binding position before the start of the sheet binding operation. As illustrated in FIG. 14B, at the same time when the driver 51 moves downward, the pressing member 54 that is supported via the spring 55 descends.

Even when the driver 51 moves downward to a certain position, the driver 51 does not come into contact with the staple 529. However, before the driver 51 comes into contact with the staple 529, the pressing member 54 comes into contact with and presses the staple holder 52. The staple holder 52 that is pressed by the pressing member 54 includes the first stamp 522. The first stamp 522 is disposed so as to come into contact with the sheet bundle Sb as the staple holder 52 descends before the driver 51 presses the staple 529. Accordingly, when the staple holder 52 is pressed down by the pressing member 54 in a state where the driver 51 is not in contact with the staple 529, the first stamp 522 comes into contact with the sheet bundle Sb before the staple 529 contacts the sheet bundle Sb. By this contact, for example, the liquid ink is transferred to the sheet bundle Sb, and the mark is applied.

Subsequently, as illustrated in FIG. 14C, the spring 55 is contracted with the first stamps 522 being sufficiently pushed into the sheet bundle Sb, and thus the staple holder 52 stops moving downward at the position where the spring 55 is not further contracted. Subsequently, even though the driver 51 is capable of moving downward, the driver 51 stops moving downward and then upward before the driver 51 contacts the staple 529.

Subsequently, as the sheet bundle Sb is taken out from the sheet binder 100, the mark of the position (the processing position) where the sheet binding operation is to be performed can be applied in the state where the user recognizes.

More specifically, the user can recognize that the staple 529 is to be used for binding on a virtual straight line that is within (between) the first stamps 522 on the left and right sides and connects the marks 5211 on the left and right sides.

As the driver 51 is continuously lowered from the state of FIG. 14C to the state of FIG. 14D, the staple 529 is pressed down and penetrates the sheet bundle Sb, and then the sheet binding operation as illustrated in FIG. 14E is performed.

### Fourth Example of Processing Position Marking Mechanism 50

A description is given below of a fourth example of a processing position marking mechanism 50 included in the sheet binder 100 according to the present embodiment.

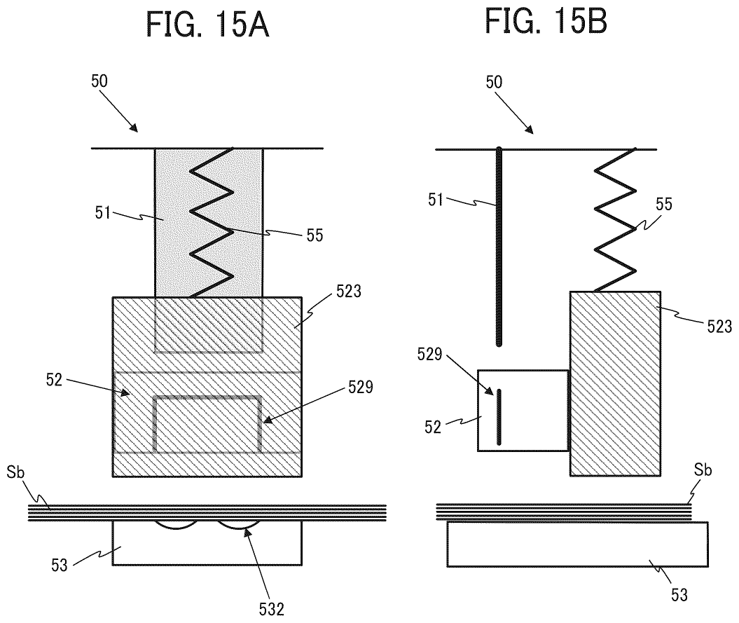

FIGS. 15A and 15B are diagrams illustrating a schematic configuration of the processing position marking mechanism 50 according to the fourth example.

In the third example, the first stamp 522 is disposed on the outer edge of the staple holder 52. In the fourth example, a second stamp 523 is disposed not on the outer edge of the staple holder 52 but is disposed on the back face of the staple holder 52. FIG. 15A is a front view of the processing position marking mechanism 50 according to the present example. FIG. 15B is a side view of the processing position marking mechanism 50 according to the present example.

The second stamp 523 is fixed to the back face of the staple holder 52. When the second stamp 523 contacts the sheet bundle Sb, the second stamp 523 transfers a material such as liquid ink for the mark of the application position when the second stamp 523 comes into contact with the uppermost sheet S of the sheet bundle Sb. Unlike the third example, the second stamp 523 is supported by the spring 55, and the staple holder 52 is supported at a given position by the second stamp 523. The second stamp 523 is a separate unit from the driver 51 that pushes out the staple 529 stored inside the staple holder 52. One end of the spring 55 is fixed to a portion to which the driver 51 is fixed. The other end of the spring 55 supports the second stamp 523. Accordingly, as the driver 51 moves for the sheet binding operation, the spring 55 also moves. Then, the second stamp 523 supported by the spring 55 also moves in the same direction at the same time.

The lowermost end of the second stamp 523 is located below the lowermost end of the staple holder 52. This position provides the relative positions that, as the driver 51 moves downward, the second stamp 523 comes into contact with the uppermost sheet S of the sheet bundle Sb before the driver 51 reaches the position where the driver 51 pushes out the staple 529.

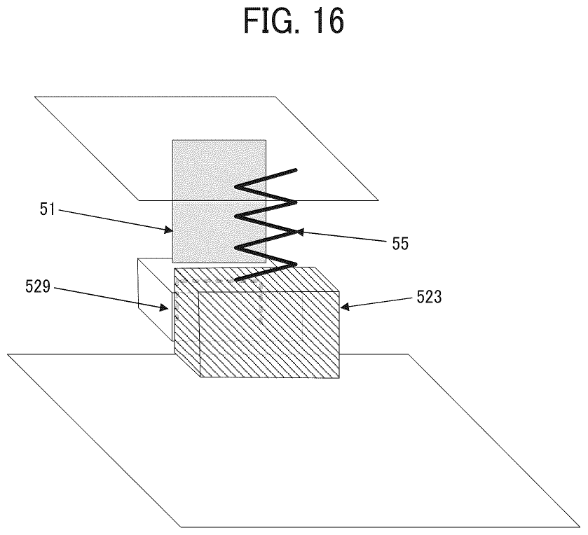

FIG. 16 is a perspective view of the processing position marking mechanism 50 according to the fourth example, illustrating the relative positions of the driver 51 and the second stamp 523.

In FIG. 16, the staple holder 52 and the clincher 53 are omitted. As illustrated in FIG. 16, the staple 529 is located at a position corresponding to the sheet binding position for binding the sheet bundle Sb, and the position where the sheet binding operation is performed corresponds to the vicinity of the outer edge of the sheet bundle Sb. The driver 51 is disposed at a position where the driver 51 can press the staple 529 upward in the vicinity of the outer edge.

The second stamp 523 is disposed at a position where the driver 51 does not hinder the pressing operation of the staple 529 and where the operation for indicating the processing position can be performed. For example, the second stamp 523 is disposed at a position where the driver 51 is disposed, that is, a position corresponding to the outside of the outer edge of the sheet bundle Sb. The second stamp 523 supports the staple holder 52 that is downwardly movable at the position.

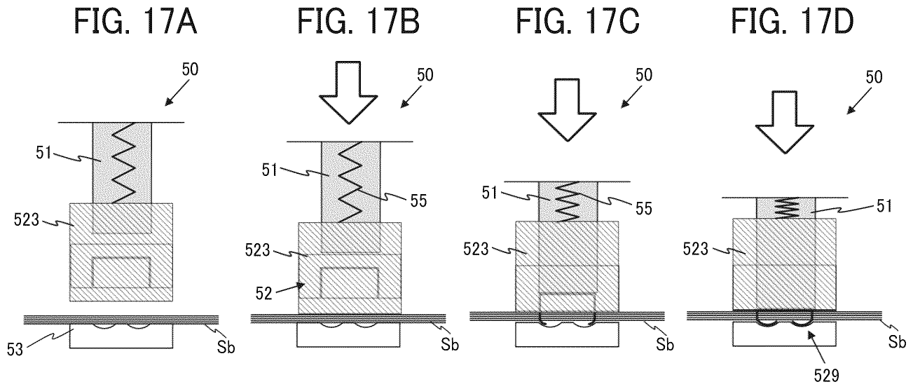

Then, a description is given of the manual binding operation according to the fourth example, with reference to FIGS. 17A, 17B, 17C and 17D.

FIGS. 17A, 17B, 17C and 17D are diagrams illustrating a manual binding operation according to the fourth example.

FIG. 17A illustrates a state where the driver 51 and the second stamp 523 are at the home position that is the sheet binding position before the start of the sheet binding operation. As illustrated in FIG. 17B, at the same time when the driver 51 moves downward, the second stamp 523 that is supported via the spring 55 and the staple holder 52 that is held by the second stamp 523 descend.

Although the driver 51 does not contact the staple 529 even when the driver 51 moves downward to a certain position, the second stamp 523 comes into contact with the sheet bundle Sb prior to the staple 529, so that the second stamp 523 transfers, for example, liquid ink onto the sheet bundle Sb to form the marks (indication) on the sheet bundle Sb.

Subsequently, as illustrated in FIG. 17C, the spring 55 is contracted with the second stamp 523 being sufficiently pushed into the sheet bundle Sb, and thus the staple holder 52 stops moving downward at the position where the spring 55 is not further contracted. Subsequently, the driver 51 can be moved downward.

At this time, the driver 51 stops moving downward before contacting the staple 529, then the driver 51 moves upward, and the sheet bundle Sb is taken out from the sheet binder 100. As a result, the user can visually recognize the mark indicating the position (processing position) at which the sheet binding operation is to be performed.

As the driver 51 is continuously lowered from the state of FIG. 17C to the state of FIG. 17D, the staple 529 is pressed down and penetrates the sheet bundle Sb, and then the sheet binding operation as illustrated in FIG. 17E is performed.

### Fifth Example of Processing Position Marking Mechanism 50

A description is given below of a fifth example of a processing position marking mechanism 50 included in the sheet binder 100 according to the present embodiment.

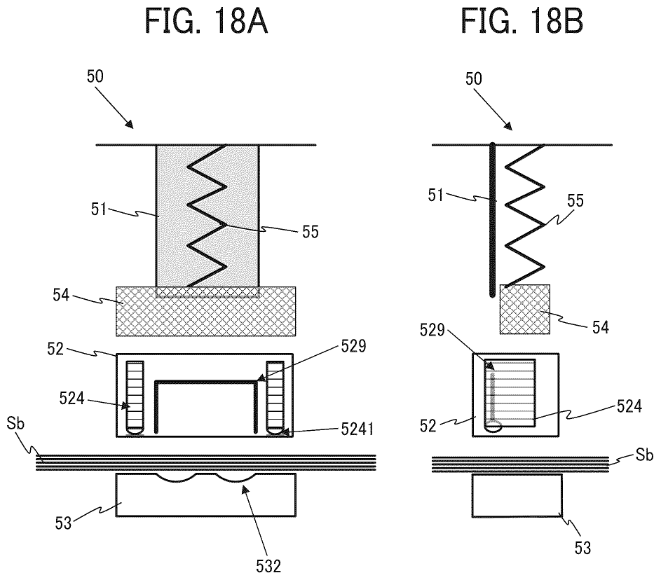

FIGS. 18A and 18B are diagrams illustrating a schematic configuration of the processing position marking mechanism 50 according to the fifth example.

In the second example, the first stamp 522 is disposed on the outer edge of the staple holder 52. In the fifth example, a third stamp 524 is disposed not on the outer edge of the staple holder 52 but is disposed inside the staple holder 52.

FIG. 18A is a front view of the processing position marking mechanism 50 according to the present example. FIG. 18B is a side view of the processing position marking mechanism 50 according to the present example.

The third stamp 524 is disposed inside the staple holder 52. As the third stamp 524 is pressed by the pressing member 54, protruding portions 5241 containing the liquid ink protrudes from the staple holder 52. For example, as illustrated in FIG. 18B, a portion pressed by the pressing member 54 protrudes toward the back side, and the protruding portions 5241 that come into contact with the sheet bundle Sb to provide marks are disposed in front of the pressing member 54. The third stamp 524 is disposed on the opposite sides across the staple 529. The staple 529 is located on the virtual straight line connecting the protruding portions 5241 of the third stamp 524.

When the protruding portions 5241 contacts the sheet bundle Sb, a material such as liquid ink that is used to indicate a position when applied to the sheet S is transferred onto the sheet bundle Sb. Similarly to the first example, the pressing member 54 is supported by the spring 55. The pressing member 54 is a separated member from the driver 51 that pushes out the staple 529 that is stored in the staple holder 52. One end of the spring 55 is fixed to a portion to which the driver 51 is fixed. The other end of the spring 55 supports the pressing member 54. Accordingly, as the driver 51 moves for the sheet binding operation, the spring 55 also moves. Then, the pressing member 54 supported by the spring 55 also moves in the same direction at the same time.

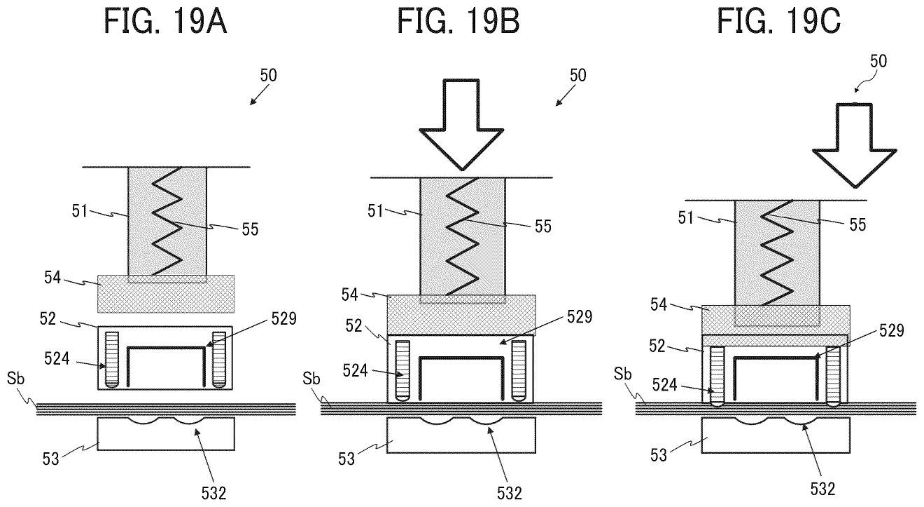

A description is given of the manual binding operation according to the fifth example, with reference to FIGS. 19A, 19B and 19C.

FIGS. 19A, 19B and 19C are diagrams illustrating a manual binding operation according to the fifth example.

FIG. 19A illustrates a state where the driver 51 and the pressing member 54 are at the home position that is the sheet binding position before the start of the sheet binding operation. As illustrated in FIG. 19B, at the same time when the driver 51 moves downward, the pressing member 54 that is supported via the spring 55 descends.

As the pressing member 54 presses the staple holder 52, the staple holder 52 also descends.

Although the driver 51 does not contact the staple 529 even when the driver 51 moves downward to a certain position, the pressing member 54 is pressed down, so that the protruding portions 5241 of the third stamp 524 comes into contact with the sheet bundle Sb before the staple 529 contacts the sheet bundle Sb. This state is illustrated in FIG. 19B. In this state, for example, the liquid ink is transferred to the sheet bundle Sb, and the mark of the sheet binding position is applied. More specifically, the user can recognize that the staple 529 is to be used for binding on a virtual straight line that is inside each of the sheet binding positions transferred and indicated and right sides and connects the sheet binding positions.

Subsequently, as illustrated in FIG. 19C, the spring 55 is contracted with the third stamp 524 being sufficiently pushed into the sheet bundle Sb, and thus the staple holder 52 stops moving downward at the position where the spring 55 is not further contracted. Subsequently, the driver 51 can be moved downward.

At this time, the driver 51 stops moving downward before contacting the staple 529, then the driver 51 moves upward, and the sheet bundle Sb is taken out from the sheet binder 100. As a result, the user can visually recognize the mark indicating the position (processing position) at which the sheet binding operation is to be performed.

Since the description of the operation when the downward movement of the driver 51 is further continued from the state illustrated in FIG. 19C is the same as the description in the second example, the description of the fifth example is omitted.

### Sixth Example of Processing Position Marking Mechanism 50

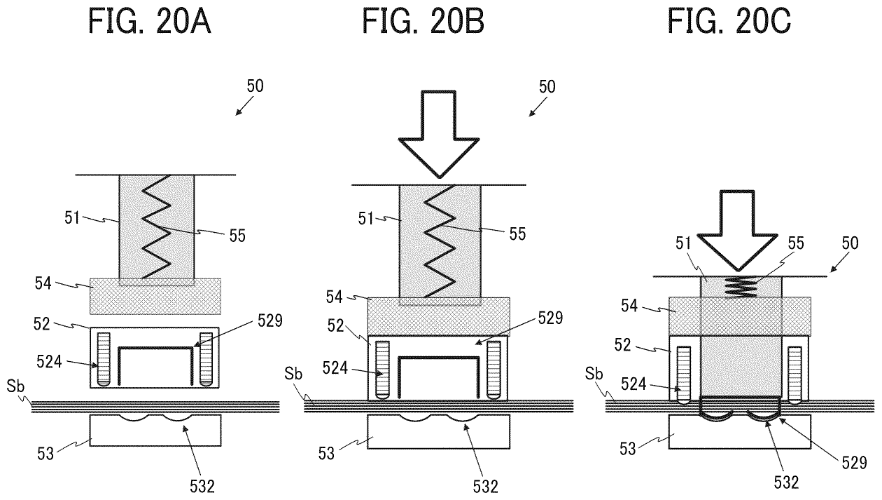

A description is given of a sixth example of the processing position marking mechanism 50 according to a modification of the fifth example, with reference to FIGS. 20A, 20B and 20C.

In the processing position marking mechanism 50 according to the present example, when the sheet binding operation is performed without indicating the sheet binding position, only the driver 51 can be moved downward even if the pressing member 54 is caused to stop the operation of descending the lowering the staple holder 52 in the middle of the operation.

A description is given of the manual binding operation according to the sixth example, with reference to FIGS. 20A, 20B and 20C.

FIGS. 20A, 20B and 20C are diagrams illustrating a manual binding operation according to a sixth example of a processing position marking mechanism included in the sheet processing apparatus.

FIG. 20A illustrates a state where the driver 51 and the pressing member 54 are at the home position that is the sheet binding position before the start of the sheet binding operation. As illustrated in FIG. 20B, at the same time when the driver 51 moves downward, the pressing member 54 that is supported via the spring 55 descends. As the pressing member 54 presses the staple holder 52, the staple holder 52 also descends.

The processing position marking mechanism 50 according to the sixth example stops the descending of the pressing member 54 at a predetermined position. Although the driver 51 does not contact the staple 529 even when the driver 51 moves downward to a certain position, the pressing member 54 presses down the staple holder 52. Due to the pressing of the pressing member 54, the staple holder 52 descends. Then, a restrictor causes the pressing member 54 to stop descending at the position immediately before the protruding portions 5241 of the third stamp 524 contact the sheet bundle Sb.

Subsequently, with the descending of the pressing member 54 being stopped, the driver 51 moves downward as illustrated in FIG. 20C. Due to this action, the staple 529 penetrates the sheet bundle Sb to perform the sheet binding operation. After the state of FIG. 20C, the driver 51 is moved upward to take out the sheet bundle Sb.

As described above, when the mark of the sheet binding position is not applied, in other words, when the user does not need to confirm the sheet binding position in advance, the processing position marking mechanism according to the sixth example is to control the operation of the driver 51 and the operation of the pressing member 54 to move the staple 529 downward, without causing a mechanism for applying the mark of the sheet binding position (the third stamp 524) to contact the sheet bundle Sb.

### First Example of Processing Position Marking Operation

A description is given below of a first example of a processing position marking operation included in the sheet binder 100.

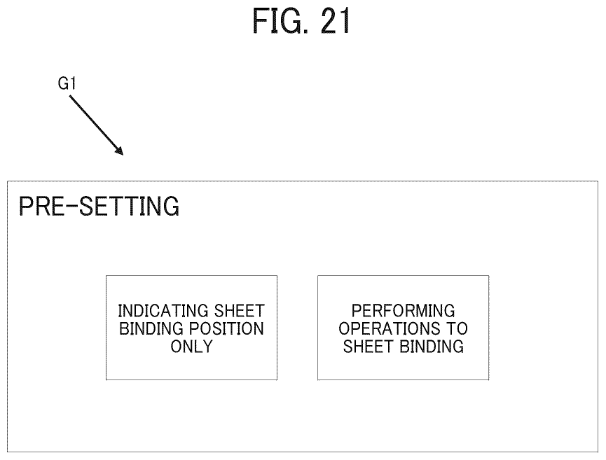

FIG. 21 is a diagram illustrating an example of a first setting screen G1 that can be displayed on an operation display unit 110 included in the image forming apparatus 1 on which the sheet binder 100 is attached.

As illustrated in FIG. 21, the first setting screen G1 as a selection unit is a screen for selecting and pre-setting a processing mode. When the operation button for selecting the setting of “indicating sheet binding position only” is pressed on the first setting screen G1, the pre-setting is made as the display processing mode. Further, when an operation button for selecting the setting of “performing operations to sheet binding” is pressed on the first setting screen G1, the presetting is made as the sheet processing mode. By performing any of the settings before performing the manual binding, the operation of the sheet binder 100 when the start button 24 is pressed can be selected. The term “marking” is synonymous with applying a mark of the sheet binding position.

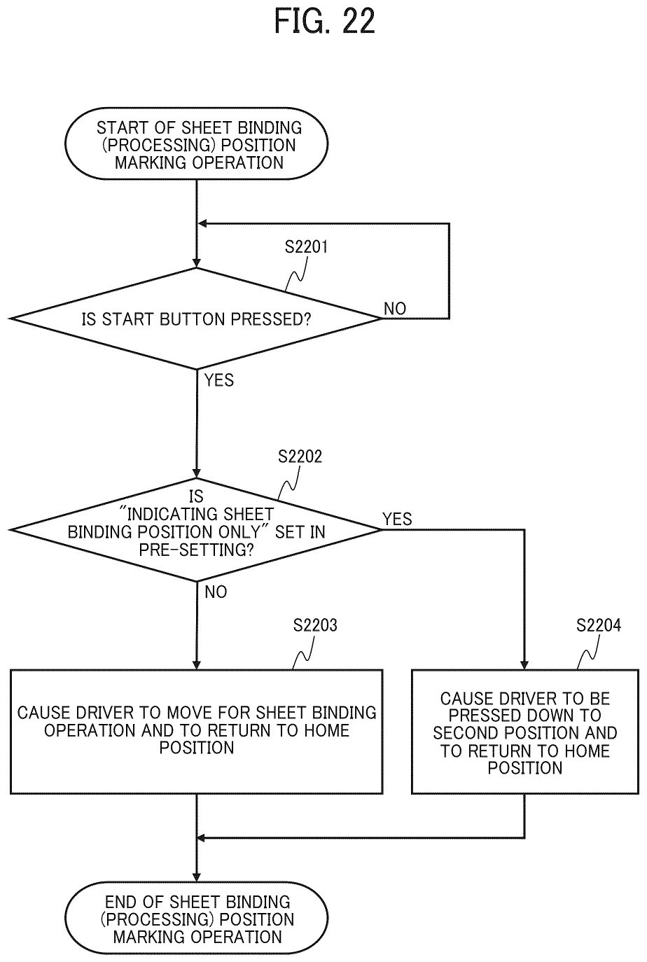

FIG. 22 is a flowchart according to the first example of the processing position marking operation.

It is assumed that the pre-setting has been completed by the first setting screen G1 illustrated in FIG. 21. In step S2201, the controller 150 determines whether the start button 24 is pressed after the sheet bundle Sb is inserted in the slit 23. When the start button 24 is not pressed (NO in step S2201), the process of the flowchart goes in the standby state and step S2201 is repeated until the start button 24 is pressed. When the start button 24 is pressed (YES in step S2201), the controller 150 subsequently determines the content of the pre-setting, in other words, whether the setting of “indicating sheet binding position only” is set in the pre-setting (step S2202).

When the content of the pre-setting is not “indicating sheet binding position only” (NO in step S2202), the sheet binder 100 (the controller 150) causes the driver 51 to move to be pressed to the position illustrated in FIG. 8E so that the sheet binder 100 performs the sheet binding operation, and then causes the driver 51 to return to the home position (step S2203). The home position corresponds to a position of the driver 51 when the driver 51 holds the sheet bundle Sb in a state where the sheet bundle Sb can be inserted into the slit 23. The home position is referred to as a “first position”. Further, the position of the driver 51 when the mark is applied to the sheet bundle Sb is referred to as a “second position”.

When the content of the pre-setting is “indicating sheet binding position only” (YES in step S2202), the sheet binder 100 (the controller 150) causes the driver 51 to move to be pressed to the position (the second position) illustrated in FIG. 8C, and then causes the driver 51 to return to the home position (the first position) (step S2204). The manual binding mode is not supposed to be released at the time when the processing of steps S2203 and S2204 is completed.

The first example of the processing position marking operation is the processing applicable to all the examples of the processing position marking mechanism 50.

After the mark of the sheet binding position is applied in step S2204, the user takes out the sheet bundle Sb from the slit 23, visually recognizes the marks of the binding position, and determines whether the sheet binding position is appropriate or not.

If the sheet binding position is a suitable position, the user makes the sheet binder 100 to be ready to perform the sheet binding operation in step S2203, inserts the sheet bundle Sb into the slit 23 again, and presses the start button 24.

Accordingly, when the setting of “performing operations to sheet binding” illustrated in FIG. 21 is performed, the user determines in advance that the sheet binding position is a suitable position.

### Second Example of Processing Position Marking Operation

A description is given of the processing position marking operation according to a second example.

The processing position marking operation according to this example can select whether to perform the sheet binding operation or the processing position marking operation, by operating the start button 24 without making the pre-setting as in the first example.

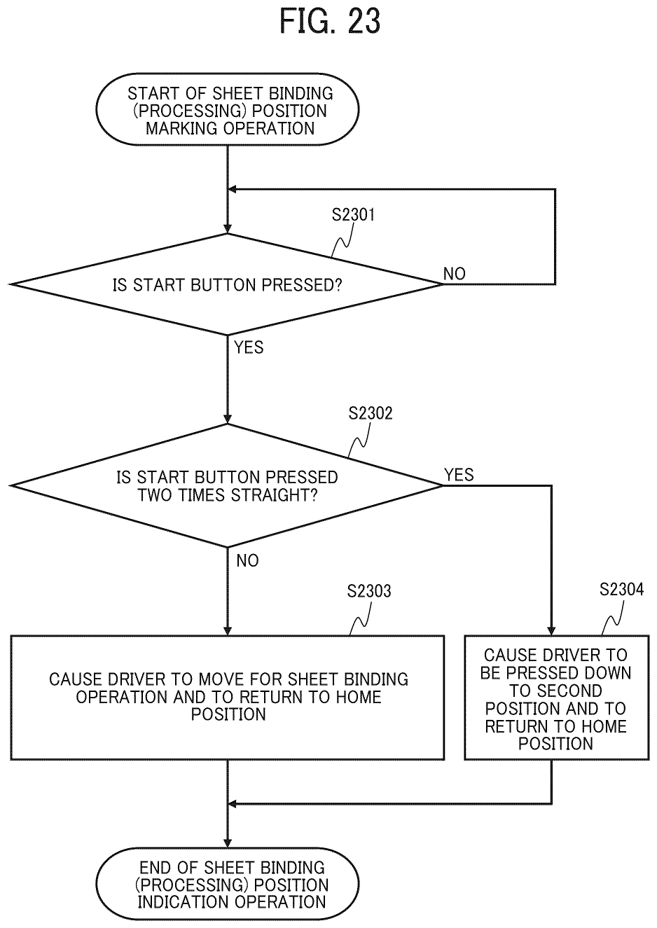

FIG. 23 is a flowchart according to the second example of the processing position marking operation.

In step S2301, the controller 150 determines whether the start button 24 is pressed after the sheet bundle Sb is inserted in the slit 23. When the start button 24 is not pressed (NO in step S2301), the process of the flowchart goes in the standby state and step S2301 is repeated until the start button 24 is pressed. When the start button 24 is pressed (YES in step S2301), the controller 150 subsequently determines the operation of the start button 24, in other words, whether the start button 24 is pressed two times straight (step S2302).

When the start button 24 is pressed (YES in step S2301) but is not pressed two times straight (NO in step S2302), the sheet binder 100 (the controller 150) causes the driver 51 to move to be pressed to the position (the first position) illustrated in FIG. 8E so that the sheet binder 100 performs the sheet binding operation, and then causes the driver 51 to return to the home position (step S2303).

When the start button 24 is pressed two times straight (YES in step S2302), the sheet binder 100 (the controller 150) causes the driver 51 to move to be pressed to the position (the second position) illustrated in FIG. 8C, and then causes the driver 51 to return to the home position (the first position) (step S2304). The manual binding mode is not supposed to be released at the time when the processing of steps S2303 and S2304 is completed.

As in the first example, the second example of the processing position marking operation is the processing applicable to all the examples of the processing position marking mechanism 50.

After the mark of the sheet binding position is applied in step S2304, the user takes out the sheet bundle Sb from the slit 23, visually recognizes the marks of the sheet binding position, and determines whether the sheet binding position is appropriate or not. If the sheet binding position is a suitable position, the sheet bundle Sb is inserted into the slit 23 again to perform the sheet binding operation of step S2303, and the start button 24 is pressed once.

Accordingly, the timing when the start button 24 is pressed once from the start is the timing when the user has determined in advance that the sheet binding position is a suitable position.

### Second Embodiment of Sheet Binder 100

A description is given below of the sheet binder 100 according to a second embodiment of the present disclosure.

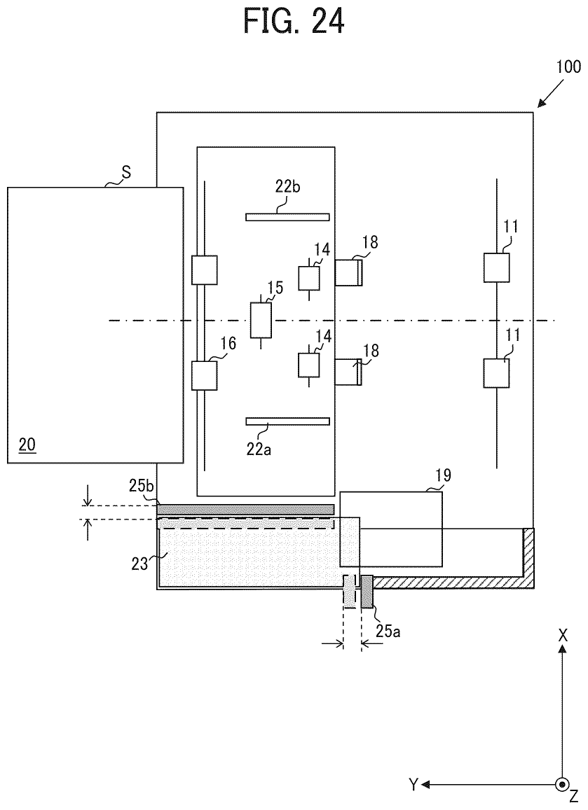

FIG. 24 is a plan view of the sheet binder 100 according to the present embodiment.

The dot-dashed line in FIG. 3 indicates the reference position that is the center in the width direction of the sheet S that is conveyed and ejected in the main body 100m.

As illustrated in FIG. 24, the sheet binder 100 according to the present embodiment includes a stopper 25a and a stopper 25b, each of which is adjustable of the position of the sheet S (sheet bundle Sb). The stopper 25a restricts the edge in the Y direction of the sheet S (sheet bundle Sb) that is manually inserted in the slit 23. The stopper 25b restricts the edge in the X direction that is another end side of the sheet S. The user manually changes the positions of the stopper 25a and the stopper 25b within the range indicated by the arrows in FIG. 24.

With the processing position marking mechanism 50 according to any one of the first example to the sixth example described above, the mark of the sheet binding position is applied, and the user temporarily takes the sheet bundle Sb out from the slit 23 before completion of the sheet binding operation, so that the user can check the marks of the sheet binding position. At this time, when the mark of the sheet binding position is different from the desired position for the user, the positions of the stopper 25a and the stopper 25b are changed. After the change of the stopper 25a and the stopper 25b, the sheet bundle Sb is inserted into the slit 23 again and the operation of applying the mark, the mark of the processing position can be applied again with the contact position of the sheet bundle Sb inserted in the slit 23 being changed.

By repeating this operation until the mark of the sheet binding position is applied to the desired position for the user, the sheet binding operation can be performed at the desired position for the user in the manual binding.

### Third Embodiment of Sheet Binder 100

A description is given below of the sheet binder 100 according to a third embodiment of the present disclosure.

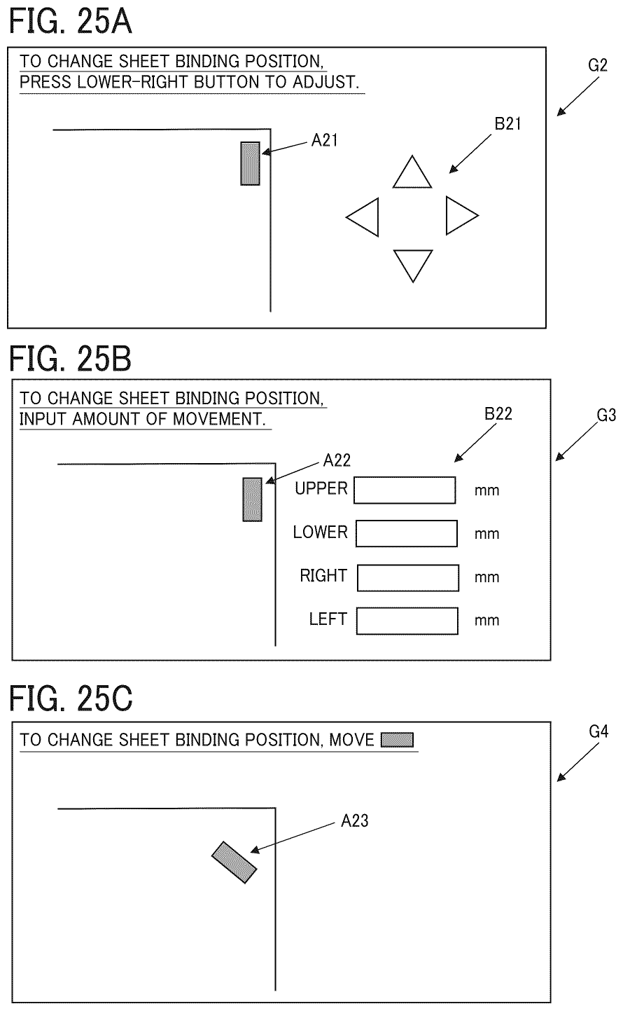

FIGS. 25A, 25B and 25C are diagrams illustrating an example of a second setting screen G2 that can be displayed on an operation display unit 110 included in the image forming apparatus 1 on which the sheet binder 100 is attached.

FIG. 25A illustrates an example of the second setting screen G2 displayed on the operation display unit 110 and includes a position change buttons B21. The user operates the position change buttons B21 that correspond to the specific directions, so that the icon A21 indicating the sheet binding position moves in the second setting screen G2. The user can adjust the sheet binding position in any direction by operating the position change buttons B21 while viewing the second setting screen G2.

FIG. 25B illustrates an example of the second setting screen G2 displayed on the operation display unit 110 and includes position designation buttons B22. When the user can designate the position of the sheet bundle from two sides of the sheet bundle by distances, the icon A22 indicating the sheet binding position is moved in the second setting screen G2 by inputting the distances. The user can adjust the sheet binding position in any direction by changing the values that are input in the position designation buttons B22 while viewing the second setting screen G2.

FIG. 25C illustrates an example of the second setting screen G2 displayed on the operation display unit 110 and includes a position change icon A23. In a case where the operation display unit 110 includes a touch screen, the user operates the position change icon A23 on the operation display unit 110 to adjust the sheet binding position to be at any position in any direction.

### Fourth Embodiment of Sheet Binder 100

A description is given below of the sheet binder 100 according to a fourth embodiment of the present disclosure.

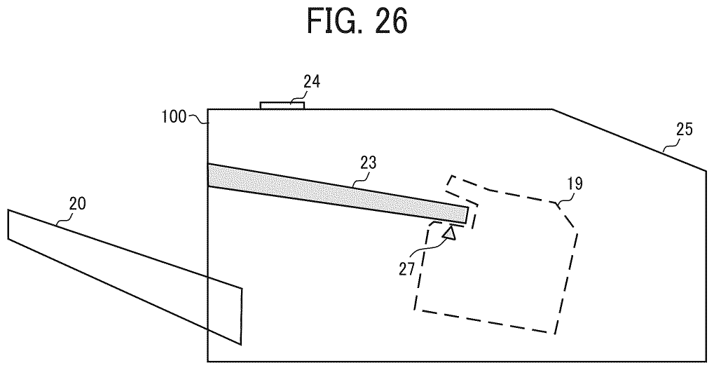

FIG. 26 is a plan view of the sheet binder 100 according to the fourth embodiment.

As illustrated in FIG. 26, the sheet binder 100 according to the present embodiment includes a sheet detection sensor 194 that detects the sheet bundle Sb. The sheet detection sensor 194 is disposed in the vicinity of the sheet binding position when the sheet bundle Sb to be inserted into the slit 23 contacts the sheet detection sensor 194.

When the sheet detection sensor 194 does not detect the sheet S or the sheet bundle Sb, the controller 150 controls not to perform the sheet binding operation even when the controller 150 detects that the user presses the start button 24. This configuration can prevent the binding unit from operating when the sheet bundle Sb is not at the sheet binding position.

### Seventh Example of Processing Position Marking Mechanism 50

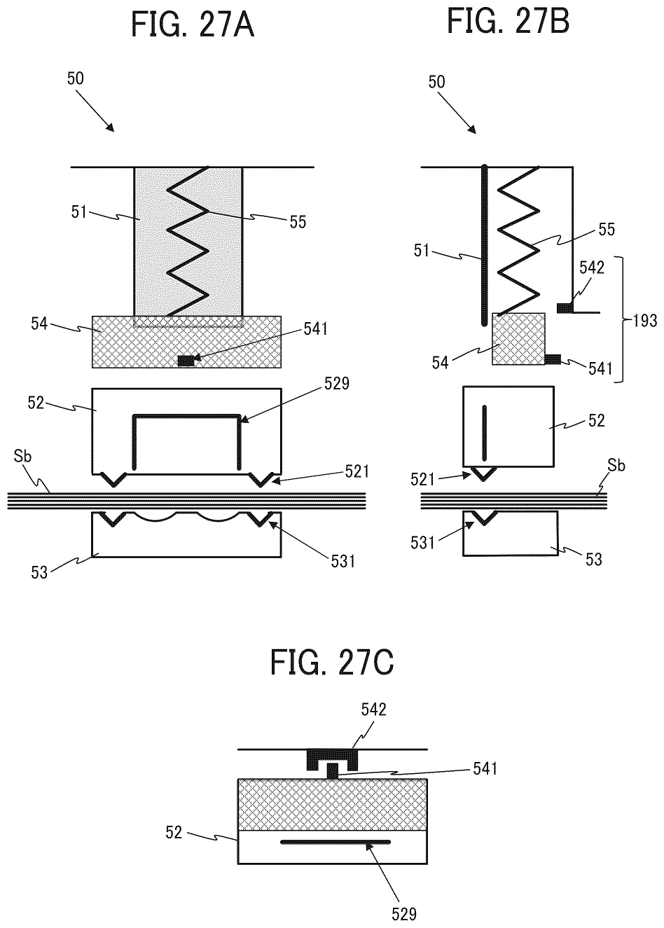

A description is given of the processing position marking mechanism 50 according to a seventh example, with reference to FIGS. 27A, 27B and 27C.

FIGS. 27A, 27B and 27C are diagrams illustrating a seventh example of the processing position marking mechanism 50.

The processing position marking mechanism 50 according to the present example includes the pressing member sensor 193 (see FIG. 5) so that the controller 150 determines the position of the pressing member 54. With the pressing member sensor 193, the controller 150 can control the position of the pressing member 54 when the pressing member 54 descends.

The pressing member sensor 193 includes a first sensor unit 541 and a second sensor unit 542 in a pair. As illustrated in FIG. 27A, the first sensor unit 541 is mounted on the pressing member 54. As illustrated in FIG. 27B, the second sensor unit 542 is mounted on the exterior cover 25. The pressing member sensor 193 is, for example, a transmission-type sensor. As illustrated in FIG. 27C, the pressing member sensor 193 detects the position of the pressing member 54 based on the relative positions of the second sensor unit 542 having a concave shape as viewed in planar view and the first sensor unit 541 having a convex shape as viewed in planar view.

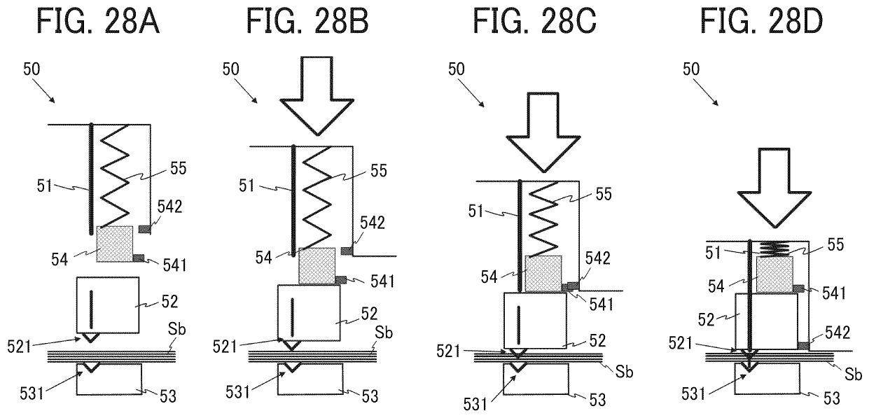

A description is given of the manual binding operation according to the seventh example, with reference to FIGS. 28A, 28B, 28C and 28D.

FIGS. 28A, 28B, 28C and 28D are diagrams illustrating the manual binding operation according to the seventh example.

FIG. 28A illustrates the processing position marking mechanism 50 in the state where the driver 51 and the pressing member 54 are at the home position that is the sheet binding position before the start of the sheet binding operation. As illustrated in FIG. 28B, at the same time when the driver 51 moves downward, the pressing member 54 that is supported via the spring 55 descends. Although the driver 51 does not contact the staple 529 even when the driver 51 is moved downward to a certain position, the staple holder 52 pressed by the pressing member 54 has the projections 521, and thus the staple holder 52 reaches the position to contact the sheet bundle Sb.

Subsequently, as illustrated in FIG. 28C, when the projections 521 are pressed against the sheet bundle Sb, in other words, when the pressing member 54 reaches the second position, the second sensor unit 542 reaches the position at the same height as the first sensor unit 541. The controller 150 determines this state to determine that the mark of the sheet binding position is applied on the sheet bundle Sb. Accordingly, when the state of FIG. 28C is reached, if the controller 150 causes the driver 51 to move upward, the sheet bundle Sb can be in a state where the mark of the sheet binding position is applied to the sheet bundle Sb.

Further, as illustrated in FIG. 28D, the driver 51 is further moved downward from the position in the state where the second sensor unit 542 has passed the first sensor unit 541. In response to this action, the sheet binding operation is performed.

According to the processing position marking mechanism 50 according to the seventh example, when the descending position to which the pressing member 54 applies the mark of the processing position is different due to the change in the thickness of the sheet S or the number of sheets S of the sheet bundle Sb, the controller 150 may control the descending amount of the driver 51 based on the output of the pressing member sensor 193 (the first sensor unit 541 and the second sensor unit 542).

The descending amount of the driver 51 can be controlled by controlling the driving amount of the sheet binder drive motor 192 by the controller 150. For example, when a pulse motor is used for the sheet binder drive motor 192, the descending amount can be controlled based on the number of control pulses.

If the sheet binder drive motor 192 is a direct-current (DC) motor, the magnitude of the load can be determined based on the magnitude of the drive current. In this case, a Hall element is used to detect the amount of drive current supplied to the sheet binder drive motor 192. In this case, the controller 150 determines the output of the Hall elements to determine the load amount of the sheet binder drive motor 192, and determines the degree of pressing of the pressing member 54 against the sheet bundle Sb to apply the mark of the processing position.

### Fifth Embodiment of Sheet Binder 100

A description is given below of the sheet binder 100 according to a fifth embodiment of the present disclosure.

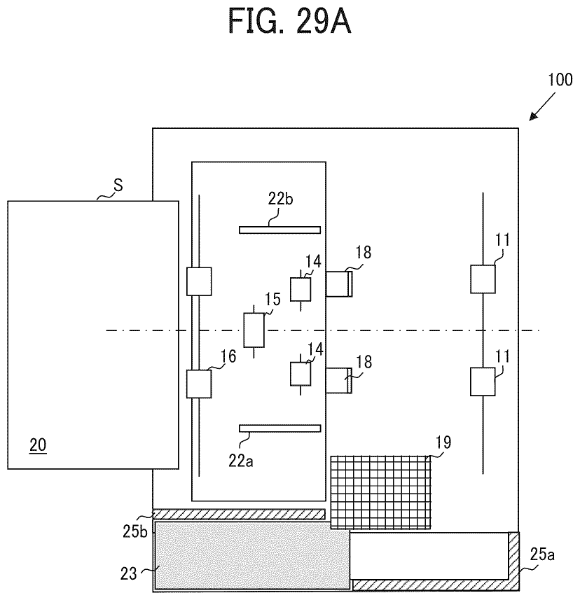

FIGS. 29A and 29B are plan views of a sheet binder according to a fifth embodiment.

As illustrated in FIGS. 29A and 29B, the sheet binder 100 according to the present embodiment moves the processing position by the binding unit (the stapler 19 in FIGS. 29A and 29B) to different positions in the automatic binding mode and the manual binding mode, and is applicable to multiple modes with a single binding unit.

FIG. 29A illustrates the position of the stapler 19 in the automatic binding mode.

FIG. 29B illustrates the position of the stapler 19 in the manual binding mode.

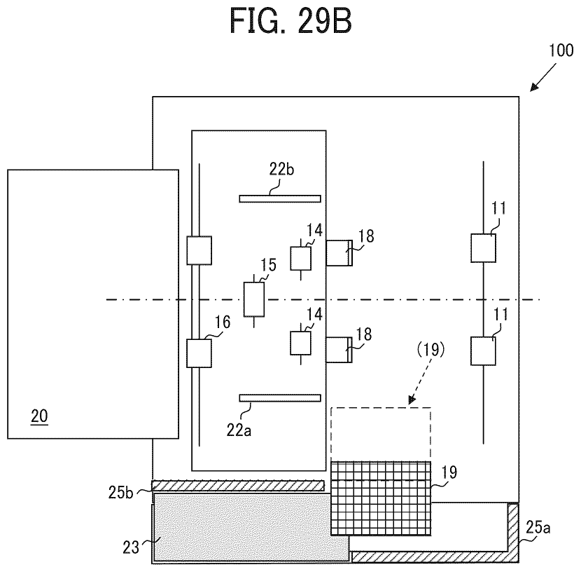

A descriptions is given below of a control process of the sheet binder 100 according to the fifth embodiment of the present disclosure, with reference to the flowchart of FIG. 30.

FIG. 30 is a flowchart of control processing performed by the sheet binder 100 according to the fifth embodiment.

When the operation of the sheet binder 100 is started, the controller 150 first receives information indicating the post-processing mode included in a job to be processed (step S3001).

Subsequently, the controller 150 determines whether the post-processing mode is the “automatic binding mode” (step S3002). When the post-processing mode is the automatic binding mode (YES in S3002), the image forming operation is performed (step S3003), and the sheet binding operation is performed (step S3004). Then, the controller 150 checks whether any subsequent information is received (step S3006). When any subsequent information is received (YES in step S3005), the process goes back to step S3001. When no subsequent information is received (NO in step S3005), the process of the flowchart in FIG. 30 ends.

In step S3002, when the post-processing mode is not the automatic binding mode (NO in S3002), as illustrated in FIG. 29B, the controller 150 causes the stapler 19 (the binding unit) to the position where the manual binding mode is executed (step S3006).

Subsequently, the controller 150 executes the operation of applying the mark of the processing position as described above, and the sheet binding operation (step S3007). Subsequently, the controller 150 determines whether the operation of applying the mark of the processing position (position marking or position indication) or the sheet binding operation is continuously performed (step S3008). When the operation of applying the mark of the processing position or the sheet binding operation is continuously performed (YES in step S3008), the controller 150 continues the operation of applying the mark of the processing position or the sheet binding operation as a loop until the operations end. When the operation of applying the mark of the processing position or the sheet binding operation ends (NO in step S3008), the controller 150 checks whether any subsequent information is received (step S3009). When any subsequent information is received (YES in step S3009), the process goes back to step S3001. When no subsequent information is received (NO in step S3009), the stapler 19 (the binding unit) is moved to the processing position for the automatic binding mode (step S3010), and the process of the flowchart in FIG. 30 ends.

### Second Embodiment of Image Forming Apparatus

A description is given of an image forming apparatus according to a second embodiment of the present disclosure.

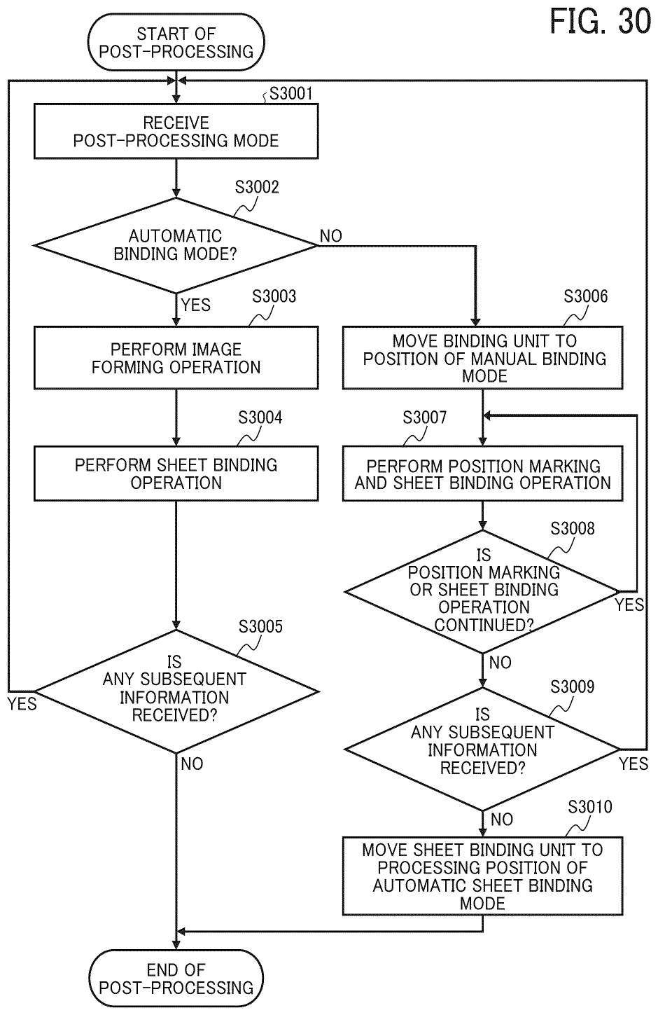

FIG. 31 is an external view of the image forming apparatus 1 according to the present embodiment.

As illustrated in FIG. 31, the image forming apparatus 1 includes the housing 31 and the image forming device 32 disposed inside the housing 31. The housing 31 has a box-shaped member having an inner space to accommodate components of the image forming apparatus 1. The housing 31 has the in-body space 33 that is accessible from the outside of the image forming apparatus 1.

The in-body space 33 is, for example, located slightly above the center of the housing 31 in the vertical direction and has a cutout portion that a part of the outer wall of the housing 31. The in-body space 33 corresponds to a portion exposed to the outside, and the user is accessible to the in-body space 33 from the outside of the housing 31. For example, a hole puncher 200 and the sheet binder 100 are attachable to the in-body space 33. The sheet binder 100 functions as a sheet processing apparatus according to an embodiment of the present disclosure.

The image forming device 32 receives a sheet S that is picked up and conveyed from a sheet tray and ejects the sheet S to the hole puncher 200 and the sheet binder 100. The image forming device 32 may include an inkjet image forming device that forms an image with ink or an electrophotographic image forming device that forms an image with toner. Since the image forming device 32 of FIG. 31 has a known configuration, a detailed description of the configuration and functions of the image forming device 32 is omitted.

The hole puncher 200 is disposed in the in-body space 33 of the image forming apparatus 1 and is located downstream from the image forming device 32 and upstream from the sheet binder 100 in a conveyance path of the sheet S from the image forming device 32 to the sheet binder 100. The conveyance passage is indicated by a dashed line and an arrow in FIG. 31. In other words, after the image forming device 32 has formed an image on the sheet S, the sheet S is conveyed to the hole puncher 200 in which a given hole punching process is performed on the sheet S. Then, the sheet S is conveyed to the sheet binder 100 in which the binding process is performed on the sheet S.

Configuration of Control Unit of Sheet Processing Apparatus and Image Forming Apparatus

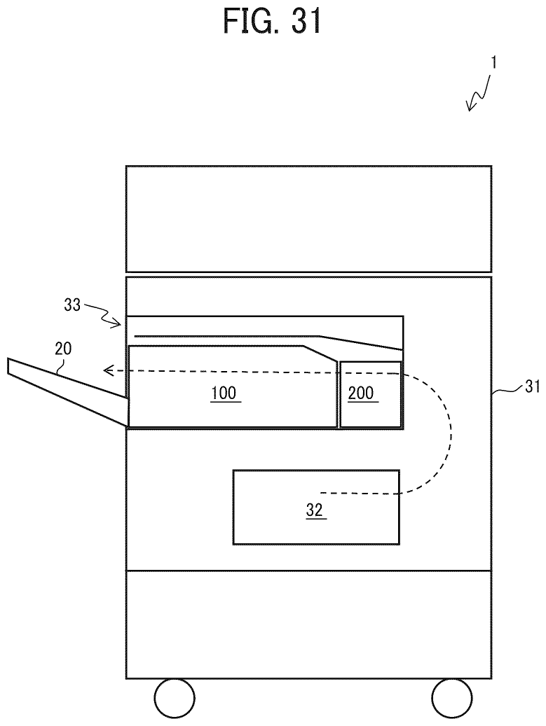

A description is now given of a configuration of a control unit of the image forming apparatus 1 including the sheet binder 100, with reference to FIGS. 32A and 32B.

FIG. 32A is a functional block diagram illustrating the image forming apparatus 1 according to an embodiment of the present disclosure, with the hole puncher 200 being removed.

FIG. 32B is a schematic diagram illustrating the internal configuration of the image forming apparatus 1 according to the present embodiment.

In FIGS. 32A and 32B, a conveyance path of the sheet S (flow of the sheet S) is indicated by an arrow in a broken line, and a path (flow of signals) of a communication signal (control signal) is indicated by an arrow in a solid line.

The image forming apparatus 1 includes a display 301, a control panel 302, and a sheet feeding device 303. The display 301 notifies the user of the state of various devices and the operation contents of the image forming apparatus 1. The control panel 302 allows the user to set, for example, an operation mode and the number of copies of the sheet bundles Sb to be printed. The sheet feeding device 303 stocks sheets S and feeds the sheets S one by one.

The image forming apparatus 1 according to the present embodiment illustrates an example of a schematic configuration of an electrophotographic image forming apparatus.

Accordingly, the image forming apparatus 1 further includes an image forming unit 304 and a fixing device 305. The image forming unit 304 forms a latent image on a photoconductor and transfers the image onto the sheet S. The fixing device 305 fixes the image transferred on the sheet S to the sheet S. The image forming apparatus 1 further includes an image forming controller 306 that controls various operations of the devices and units described above.

In the sheet binder 100 as a sheet processing apparatus causes the image forming controller 306 of the image forming apparatus 1 to instruct, through a communication line 307, a binder controller 102 to cause a binder processing unit 101 to perform the designated processing on the designated sheet S.

The image forming controller 306 and the binder controller 102 are connected to each other via the communication line 307 to exchange information between the image forming controller 306 and the binder controller 102. By so doing, information on, for example, the operation mode, the size of the sheet S, and the timing are exchanged to make the system operable.

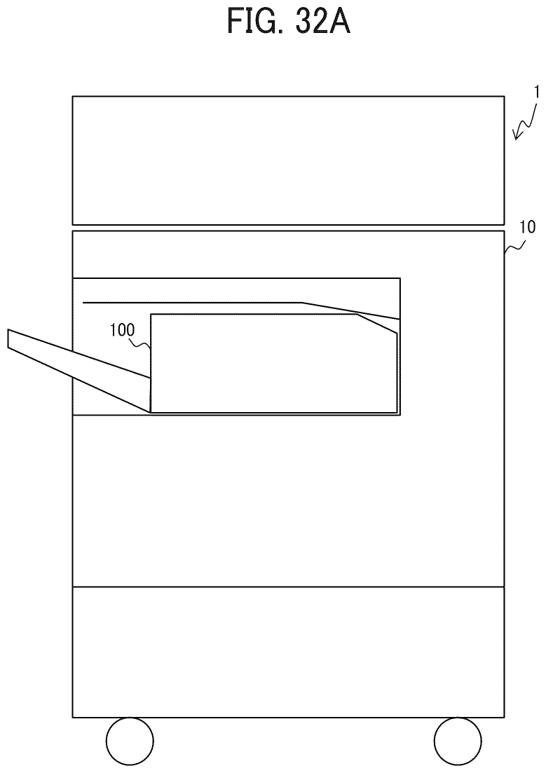

FIG. 33A is a diagram (functional block) illustrating another control configuration of the image forming apparatus 1 strating the image forming apparatus 1 according to another embodiment of the present disclosure, with the hole puncher 200 being attached (see FIG. 31).

FIG. 33B is a schematic diagram illustrating an example of a functional block of the image forming apparatus 1 of FIG. 33A.

In FIGS. 33A and 33B, a conveyance path of the sheet S (flow of the sheet S) is indicated by an arrow in a broken line, and a path (flow of signals) of a communication signal (control signal) is indicated by an arrow in a solid line.

The image forming apparatus 1 illustrated in FIGS. 33A and 33B has the same configuration as the image forming apparatus 1 illustrated in FIGS. 32A and 32B, and includes the display 301, the control panel 302, and the sheet feeding device 303. The image forming apparatus 1 also includes the image forming unit 304 and the image forming controller 306.

In the sheet binder 100 as a sheet processing apparatus, the image forming controller 306 of the image forming apparatus 1 instructs, through a communication line 309, the binder controller 102 to cause the binder processing unit 101 to perform the designated processing on the designated sheet S. The binder processing unit 101 is notified of designated information of process contents for the sheet S via a puncher processing unit 201.

The image forming controller 306 and the binder controller 102 are connected to each other via the communication line 309 to exchange information between the image forming controller 306 and the binder controller 102. By so doing, information on, for example, the operation mode, the size of the sheet S, and the timing are exchanged to make the system operable.

In the hole puncher 200, an instruction is given from the image forming controller 306 of the image forming apparatus 1 to the binder controller 102 through a communication line 309 and from the binder controller 102 to a hole puncher controller 202 through a communication line 103 to perform a designated process on the designated processing on the designated sheet S. The hole puncher controller 202 controls the puncher processing unit 201 to perform a designated hole punching process.

### Hardware Configuration of Image Forming Apparatus 1

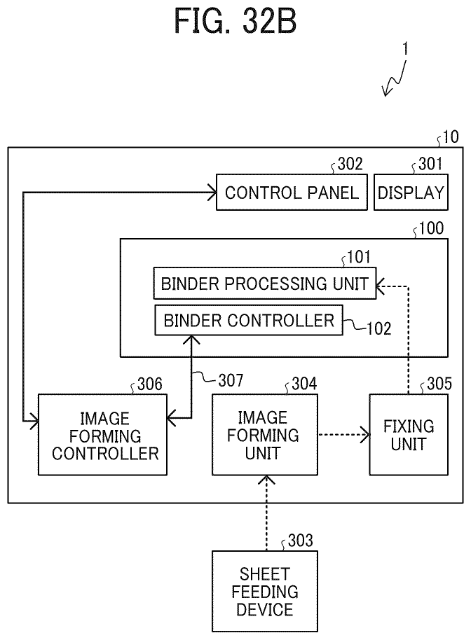

A description is given of a hardware configuration of the sheet binder 100 included in the image forming apparatus 1 according to a second embodiment of the present disclosure, with reference to FIG. 34.

The description of the hardware configuration including a punching unit 400 will be omitted.

FIG. 34 is a diagram illustrating the hardware configuration of the image forming apparatus 1 according to the second embodiment of the present disclosure.

As illustrated in FIG. 34, the sheet binder 100 includes a central processing unit (CPU) 151 as a controller. The CPU 151 is connected to multiple motors as drive sources for the operations of various mechanisms via an interface (I/F) 112. The CPU 151 is a calculation unit and controls the entire operation of the sheet binder 100.

The CPU 151 in the sheet binder 100 is connected to the image forming controller 306 of the image forming apparatus 1 via the I/F 112 to control the sheet binder 100 in accordance with a processing signal from the image forming apparatus 1. Since the sheet binder 100 is also an optional device, the hardware of the sheet binder 100 is detachable from the image forming apparatus 1.

The interface (I/F) portion in which the image forming device 300 and the sheet binder 100 are coupled to each other is mechanically detachable by, for example, a relay connector or a drawer connector. The interface (I/F) portion in which the punching unit 400 and the image forming device 300 are coupled to each other has the same configuration as the interface portion of the image forming device 300 and the sheet binder 100.

The drive motors for driving multiple conveyance roller pairs to perform the sheet binding operation in the sheet binder 100 has encoders that can detect the amount of driving force of each motor based on the number of pulses. Accordingly, the image forming apparatus 1 can cause the conveyance roller pairs to be driven and stopped at respective positions of each specific driving amount from a specific timing as a starting point, and can achieve the control for conveying the sheet S in a given direction by a given amount.

Further, the encoder pulse is measured with the timing at which the sensor on the conveyance passage is on or off as a base point, and the driving amount of each motor can be calculated based on the encoder pulse. Then, the position of the end of the sheet S being conveyed can be detected based on the calculated driving amount.

As illustrated in FIG. 34, in the binder controller 102 as a controller of the sheet binder 100, a conveyance motor 1151, an ejection motor 1152, a stapler drive motor 1153, a conveyance sensor 1154, an ejection sensor 1155, and a home position (HP) sensor 1156 are connected to the CPU 151 via an interface (I/F) 111.

In the hole puncher controller 202 as a controller of the hole puncher 200, a folder motor 162, an entrance sensor 163, and a folder sensor 164 are connected to the CPU 151 via an interface (I/F) 121.

When a punching main unit (e.g., the punching unit 400) is employed as an optional device that performs the hole punching operation on a sheet S, the controller of the punching main unit (the punching unit 400) is connected to the CPU 151. In the punching main unit (the punching unit 400), a punching unit motor 1157, a punching unit movement motor 1158, a pre-punching motor 1159, a cover open-close sensor 1160, and a punching unit HP sensor 1161 are connected to the CPU 151 via an interface (I/F) 122.

### Configuration of Conveyance Path of Sheet Binder 100

A description is given below of a configuration of the conveyance path of a sheet S included in the sheet binder 100 as a sheet processing apparatus according to an embodiment of the present disclosure.

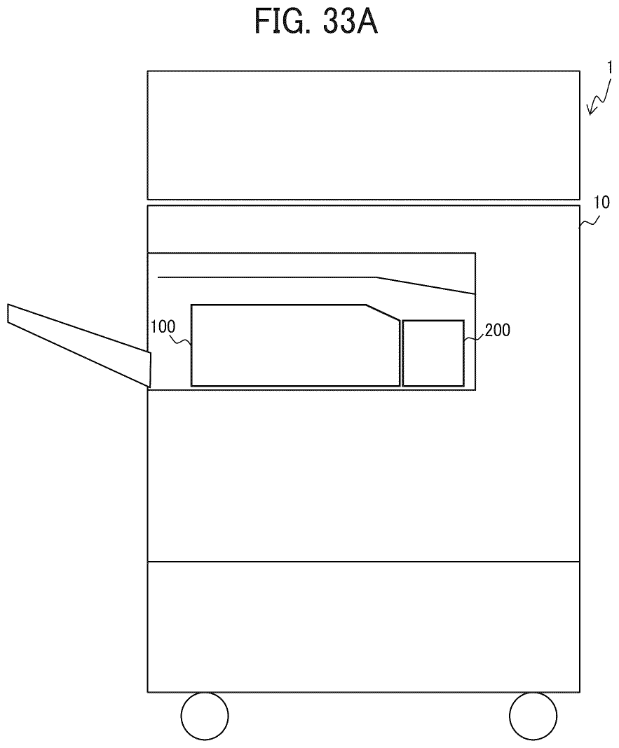

FIG. 35 is a sectional view of a conveyance path in the sheet binder 100.

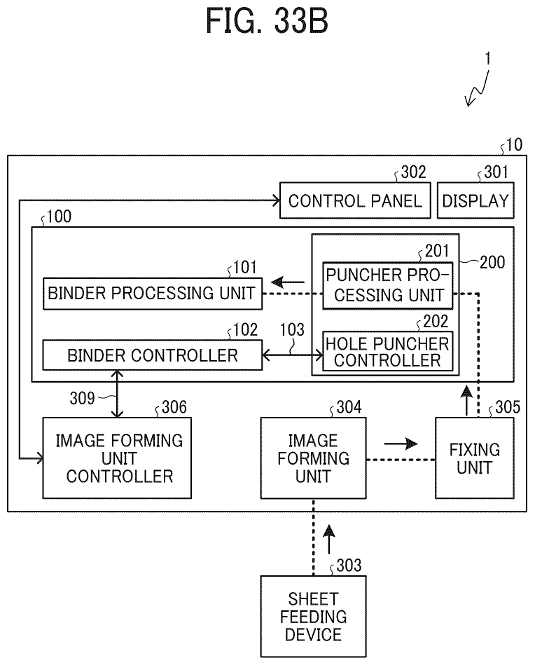

The sheet binder 100 is settable with multiple operation modes and is appropriately performed based on a set operation mode. The operating modes of the sheet binder 100 includes, for example, a “shift ejection mode” in which no binding is performed on a sheet S before the sheet S is conveyed and ejected from the upstream side (image forming device 32) to the ejection tray 20 in the conveyance direction and a “binding mode” in which a stapling or a crimp binding is performed on a sheet S by a stapler 19 or a crimp binder 26, which is omitted in FIG. 36.

FIG. 36 is a diagram illustrating a conveyance process of a sheet binder.

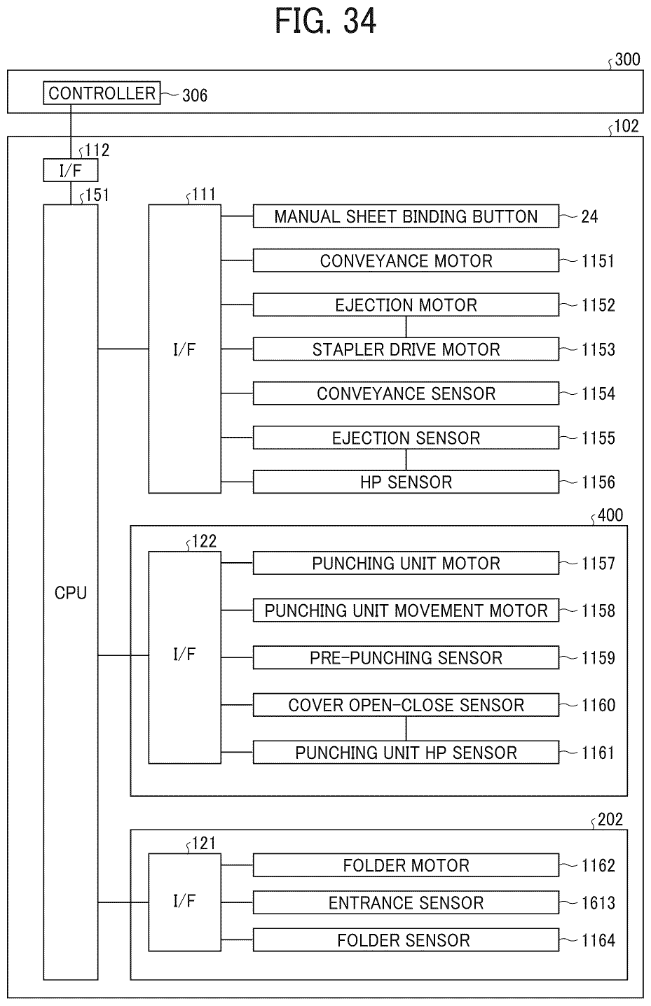

FIG. 37 is a diagram illustrating a conveyance process of the sheet binder, subsequent to the conveyance process of FIG. 36.

The binding mode includes an “automatic binding mode” in which multiple sheets S that makes a sheet bundle are stacked and aligned on the sheet tray 17 and the sheet binding operation is performed on the end portion, and a “manual binding mode” in which the sheet binding operation is performed by a manual operation of the user after the multiple sheets S are ejected to the ejection tray 20.

In the shift ejection mode, the sheet S conveyed from the image forming apparatus 1 is received by an entrance roller pair 11, and is conveyed to an ejection roller pair 16 before the sheet S is ejected to the ejection tray 20. The entrance roller pair 11, the conveyance roller pair 12, the shift roller pair 13, and the ejection roller pair 16 function as a first conveyor. In other words, when the sheet S is conveyed from the entrance roller pair 11 toward the ejection roller pair 16, the conveyance direction corresponds to a first direction.

In the binding mode, the sheet S conveyed from the image forming apparatus 1 is received by the entrance roller pair 11, and is conveyed to the shift roller pair 13 in the first direction. When the sheet S passes through the shift roller pair 13, a hitting roller 15 is driven to stack the sheet S onto the sheet tray 17 as an inner tray. Then, the hitting roller 15 and a return roller 14 conveys the sheet S in a second direction that is different from the first direction. The hitting roller 15 and the returning roller 14 function as a second conveyor. The second direction corresponds to a direction opposite to the first direction. The conveyance in the second direction at this time corresponds to a “switchback conveyance” that is a conveyance toward a reference fence 18 to align the end of the sheet S.

In the binding mode, the above-described conveyance of the sheet S in the second direction (the operation from the sheet tray 17 to the reference fence 18) is repeated until the number of sheets S becomes equal to the number of sheets to be bound. When the last sheet S is conveyed to the reference fence 18, for example, the stapler 19 as a stapling unit performs the stapling process in which a staple (or staples) penetrate the end of a bundle of sheets S (sheet bundle Sb). The bound sheet bundle Sb is conveyed in the first direction by the ejection roller pair 16 as a first conveyor and is ejected to the ejection tray 20.

The sheet S or the sheet bundle Sb ejected to the ejection tray 20 is aligned by contacting an end of the sheet S or the sheet bundle Sb against an end fence 21.

In the manual binding mode, the sheet S conveyed from the image forming apparatus 1 is received by the entrance roller pair 11, and is conveyed and ejected to the ejection tray 20 without being placed on the sheet tray 17. This operation is repeatedly performed until the number of sheets to be bound reaches the predetermined number, and the user executes a manual binding operation described below, and thus, the sheet binding operation is performed.

### Operation Process of Shift Ejection Mode

A description is now given of an operation process of a shift ejection mode among the conveyance and binding of sheets S in the sheet binder 100, with reference to multiple drawings.

The shift ejection mode starts when the sheet binder 100 receives the sheet S and conveys the sheet S in the first direction. This step is the same regardless of the operation mode. Subsequently, by the time that the sheet S is conveyed in the first direction and the leading end of the sheet S in the conveyance direction (first direction) reaches the position of the ejection roller pair 16, an ejection driven roller 16b of the ejection roller pair 16 is changed from the nipping state where the ejection driven roller 16b is disposed close to an ejection drive roller 16a to the nip pressure releasing state where the ejection driven roller 16b is separated from the ejection drive roller 16a. Then, the shift roller pair 13 is moved in the width direction (main scanning direction) of the sheet S with the trailing end of the sheet S being passed through the conveyance roller pair 12. By so doing, the sheet S is conveyed while the conveyance position of the sheet S is shifted in the main scanning direction.

Subsequently, when the shift of the sheet S is completed, the ejection driven roller 16b is moved to the nip position to convey the sheet S toward the ejection tray 20. Then, as illustrated in FIG. 37, the sheet S is ejected to the ejection tray 20 by the ejection roller pair 16.

### Operation Process of Binding Mode

A description is now given of a process of operations of a binding mode among the conveyance and binding of sheets S in the sheet binder 100, with reference to multiple drawings.

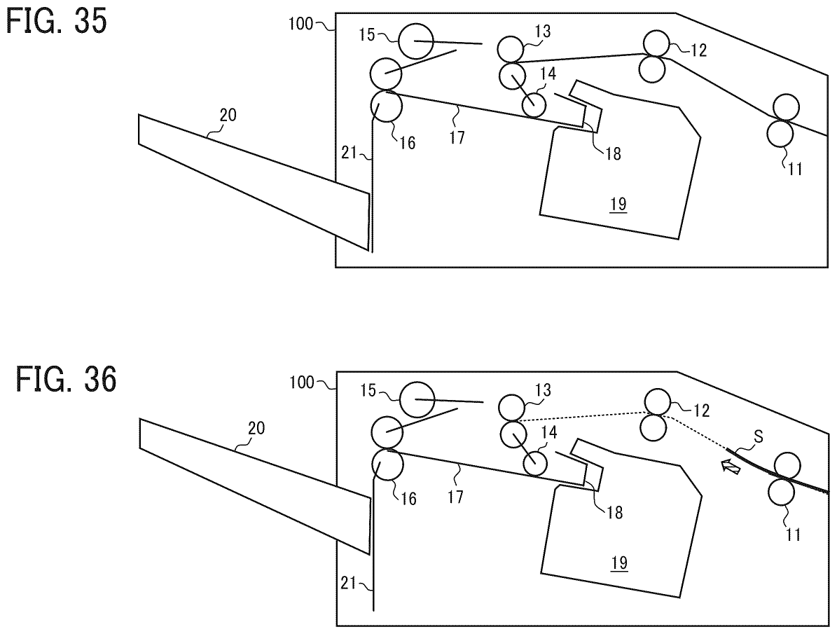

FIG. 38 is similar to FIG. 36 described above and illustrates a state where the sheet S is received in the sheet binder 100.

FIG. 38 is a diagram illustrating a conveyance process of the sheet binder 100.

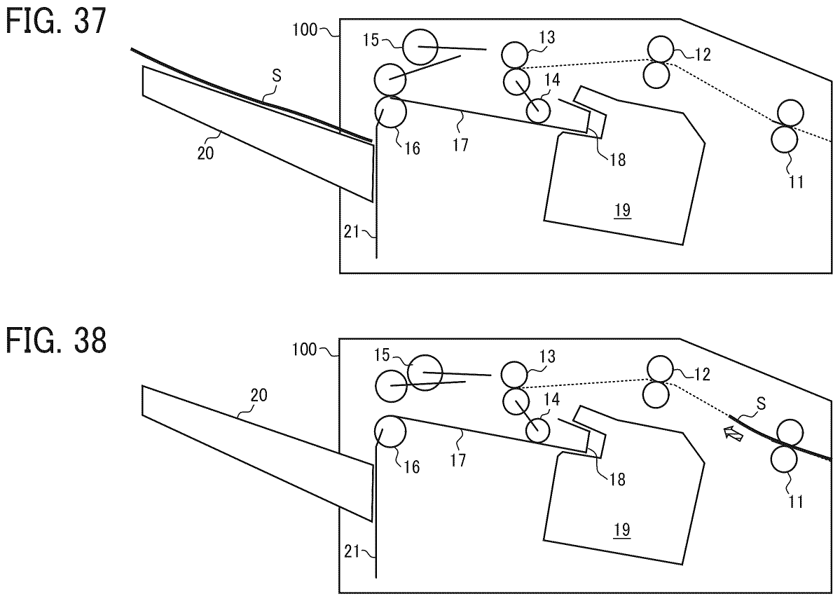

FIG. 39 is a diagram illustrating a conveyance process of the sheet binder 100, subsequent to the conveyance process of FIG. 38.

In the binding mode, the sheet S is conveyed without shifting the position from the vicinity of the center in the conveyance direction. Accordingly, the ejection driven roller 16b remains at the nip pressure releasing position and the sheet S is conveyed in the first direction. Subsequently, the sheet S whose trailing end has passed through the shift roller pair 13 falls onto the sheet tray 17 as an internal tray along with the aid of gravity. Then, the hitting roller 15 comes into contact with the sheet S placed on the sheet tray 17 and conveys the sheet S in the second direction. As a result, the sheet S is conveyed in a manner of switchback conveyance toward the reference fence 18 while being placed on the sheet tray 17.

Subsequently, the sheet S is conveyed due to the switchback conveyance by the hitting roller 15 and the return roller 14 until the end portion of the sheet S contacts the reference fence 18. The end portion of the sheet S corresponds to the leading end of the sheet S in conveyance in the second direction. After the end of the sheet S contacts the reference fence 18, the jogger fences 22 sandwich the sheet S so that the end of the sheet S in the lateral direction (width direction) contacts the jogger fences 22. Due to this operation, an alignment is performed on the end portions of the sheets S stacked on the sheet tray 17 in the width direction.

By repeatedly executing the processes, multiple sheets S are stacked on the sheet tray 17. The number of repetitions corresponds to the number of sheets S included in the sheet bundle Sb. Subsequently, as illustrated in FIG. 39, after the sheets S are placed on one another (stacked) on the sheet tray 17, the stapler 19 is used to perform crimp binding on a part (a part of the end portion) of the sheet bundle Sb. When the crimp binding operation is performed, the ejection driven roller 16b moves to the nip position.

Then, the sheet bundle Sb is ejected to the ejection tray 20 by the ejection roller pair 16.

### Sixth Embodiment of Sheet Binder 100

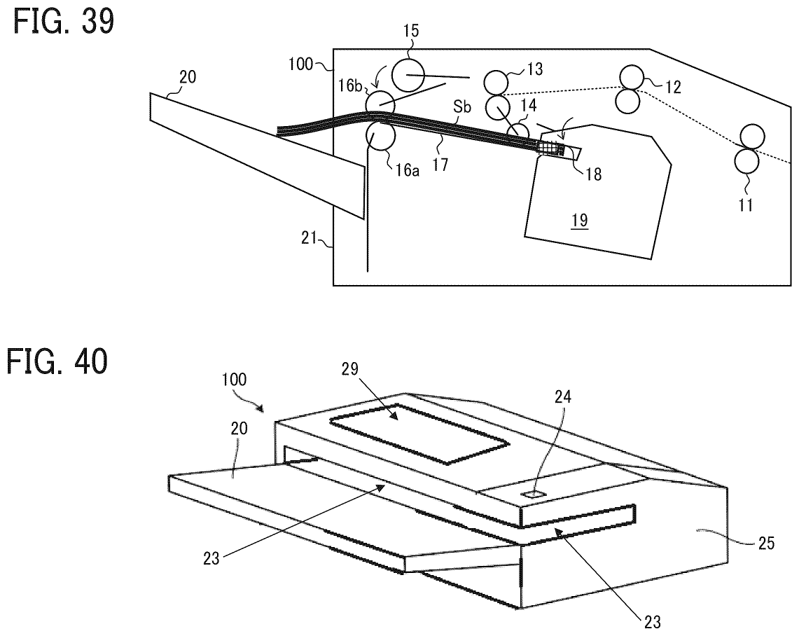

A description is given below of the sheet processing apparatus according to a sixth embodiment of the present disclosure, with reference to FIG. 40.

FIG. 40 is an external view of a sheet processing apparatus according to the sixth embodiment of the present disclosure.

The sheet binder 100 according to the present embodiment is separately operable without being coupled to the image forming apparatus 1.

As illustrated in FIG. 40, the slit 23 has an opening in two side faces of the exterior cover 25. Due to such a configuration, the sheet bundle Sb can be inserted into the sheet binder 100 according to the first embodiment, from the side where the ejection tray 20 is attached.

The sheet binder 100 according to the present embodiment includes an operation display panel 29. The operation display panel 29 displays, for example, the pre-setting screen described above and a setting screen for setting the sheet binding position, and receives a setting operation performed through these screens. Further, the above-described examples can be applied to the sheet binder 100 according to the present embodiment.

### First Embodiment of Image Forming System

A description is given below of an image forming system according to a first embodiment of the present disclosure.

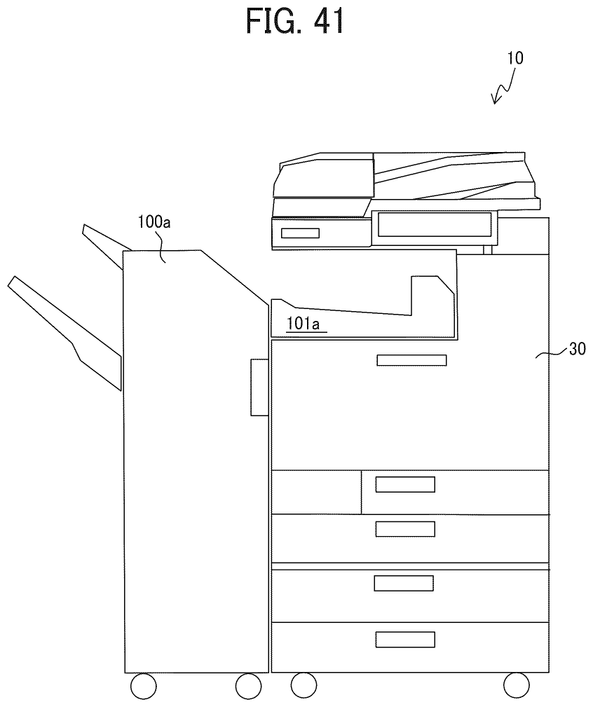

FIG. 41 is an external view of an image forming system 10 the present embodiment.

The image forming system 10 includes an image forming apparatus 30, a relay device 101a, and an external finisher 100a coupled to each other.

The external finisher 100a is another form of a finisher having the same function as the sheet binder 100 that functions as an inner finisher. After the image forming apparatus 30 forms an image on a sheet S, the external finisher 100a receives the sheet S via the relay device 101a to perform a post-processing operation such as a sheet binding process on the sheet S.

### Second Embodiment of Image Forming System

A description is given below of an image forming system according to a second embodiment of the present disclosure.

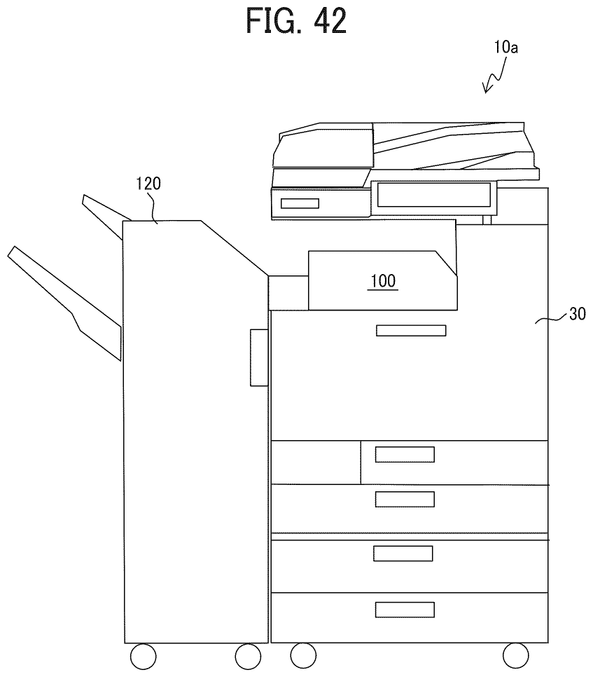

FIG. 42 is an external view of an image forming system 10a the present embodiment.

The image forming system 10a includes the image forming apparatus 30, the sheet binder 100 that functioning as a relay device, and an external finisher 120 coupled to each other.

After the image forming apparatus 30 forms an image on a sheet S, the sheet binder 100 functioning as a relay device receives to perform a post-processing operation such as a binding process on the sheet S, and the external finisher 120 disposed downstream from the sheet binder 100 in the sheet conveyance direction selectively performs sorting or another selected post-processing operation on the sheet S.

### Third Embodiment of Image Forming System

A description is given below of an image forming system according to a third embodiment of the present disclosure.

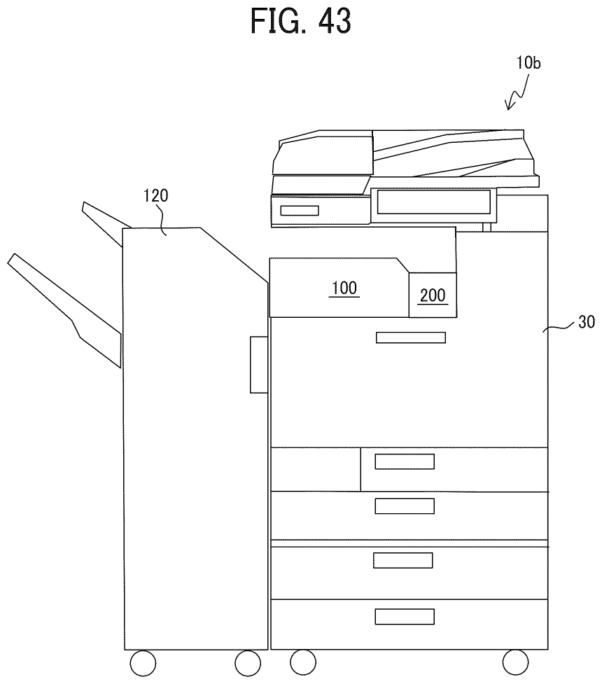

FIG. 43 is an external view of an image forming system 10b according to the present embodiment.

The image forming system 10b includes the image forming apparatus 30, the sheet binder 100 that functioning as a relay device, a hole puncher 200, and the external finisher 120 coupled to each other.

In the image forming system 10b, after the image forming apparatus 30 forms an image on the sheet S, the hole puncher 200 performs a punching operation on the sheet S. The image forming system 10b causes the sheet binder 100 functioning as a relay device to receive the sheet S to perform, for example, a sheet binding operation on the sheet S. Further, the image forming system 10b causes the external finisher 120 disposed downstream from the sheet binder 100 in the sheet conveyance direction selectively performs sorting or another selected post-processing operation on the sheet S.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such modifications are included in the technical scope described in the scope of claims.

In addition, although the first to sixth embodiments are examples in which the sheet binding position is indicated, the binding unit may be replaced with a punching unit, and the punching position may be indicated.

Aspects of the present disclosure are, for example, as follows.

### Aspect 1

In Aspect 1, a sheet processing apparatus includes an insertion portion, a sheet processing device, and a position marker. The insertion portion is a portion to which a sheet is inserted. The sheet processing device performs a predetermined operation on the sheet inserted to the insertion portion. The position marker applies a mark at a position on the sheet on which the predetermined operation is to be performed.

### Aspect 2

In Aspect 2, in the sheet processing apparatus according to Aspect 1, the mark is applied by deforming a part of the sheet by the position marker.

### Aspect 3

In Aspect 3, in the sheet processing apparatus according to Aspect 1 or Aspect 2, the position marker has a projection that contacts the sheet inserted to the insertion portion and can deform a part of the sheet.

### Aspect 4

In Aspect 4, in the sheet processing apparatus according to Aspect 1 or Aspect 2, the position marker approaches the sheet as the sheet processing device approaches the sheet, and contacts the sheet before the sheet processing device contacts the sheet.

### Aspect 5

In Aspect 5, in the sheet processing apparatus according to Aspect 4, the sheet processing device contacts the sheet with the position marker contacting the sheet.

### Aspect 6

In Aspect 6, in the sheet processing apparatus according to any one of Aspects 1 to 5, the position marker is disposed on the sheet processing device on a first side and a second side opposite to the first side.

### Aspect 7

In Aspect 7, in the sheet processing apparatus according to any one of Aspects 1 to 6, the insertion portion includes multiple aligners including a first aligner in contact with a first end of the sheet inserted in the insertion portion, and a second aligner in contact with a second end of the sheet inserted in the insertion portion. The second end is adjacent to the first end. The first aligner and the second aligner are at positions changeable with respect to the sheet processing device.

### Aspect 8

In Aspect 8, the sheet processing apparatus according to any one of Aspects 1 to 7 further includes a selector to select to execute one of a sheet processing mode to execute a predetermined process while contacting the sheet and a marking processing mode to apply the mark on the sheet.

### Aspect 9

In Aspect 9, an image forming apparatus includes an image forming device, a sheet stacker, and a sheet processing apparatus. The image forming device forms an image on a sheet. The sheet stacker is a device to which the sheet having the image is ejected. The sheet processing apparatus according to any one of Aspects 1 to 8 to perform a predetermined process while contacting the sheet having the image. The sheet processing apparatus includes a sheet processing device, and the sheet processing apparatus moves between a first position at which the predetermined process is performed on the sheet ejected to the sheet stacker and a second position at which the predetermined process is performed on the sheet having the image before the sheet is ejected to the sheet stacker.

### Aspect 10

In Aspect 10, in the image forming apparatus according to Aspect 9, the sheet processing device includes a first processing unit to perform the predetermined process on the sheet ejected to the sheet stacker, and a second processing unit at which the predetermined process is performed on the sheet having the image before the sheet is ejected to the sheet stacker.

### Aspect 11

In Aspect 11, the image forming apparatus according to Aspect 9 or Aspect 10 further comprising circuitry to execute at least one of a manual processing mode to perform the predetermined process on the sheet processing apparatus, and an automatic processing mode to perform the predetermined process on the sheet processing device.

### Aspect 12

In Aspect 12, an image forming system includes an image forming apparatus to form an image on a sheet, and the sheet processing apparatus according to any one of Aspects 1 to 8 coupled to the image forming apparatus.

### Aspect 13

In Aspect 13, a sheet processing apparatus includes an insertion portion, a sheet processing device, and a position marker. The insertion portion has an opening into which a sheet is insertable. The sheet processing device performs a predetermined operation onto the sheet inserted into the insertion portion. The position marker forms a mark at a processing position at which the predetermined operation is to be performed onto the sheet.

### Aspect 14

In Aspect 14, in the sheet processing apparatus according to Aspect 13, the position marker the position marker deforms a part of the sheet to form the mark on the sheet.

### Aspect 15

In Aspect 15, in the sheet processing apparatus according to Aspect 13 or Aspect 14, the position marker has a projection to contact and deform the part of the sheet inserted to the insertion portion to form the mark on the sheet.

### Aspect 16

In Aspect 16, in the sheet processing apparatus according to Aspect 13 or Aspect 14, the position marker is disposed closer to the sheet than the sheet processing device in a state before the sheet processing device performs the predetermined operation onto the sheet. The position marker contacts the sheet before the sheet processing device contacts the sheet.

### Aspect 17

In Aspect 17, in the sheet processing apparatus according to Aspect 16, the sheet processing device contacts the sheet while the position marker contacts the sheet.

### Aspect 18

In Aspect 18, in the sheet processing apparatus according to any one of Aspects 13 to 17, the position marker has markers on both sides of the sheet processing device.

### Aspect 19

In Aspect 19, in the sheet processing apparatus according to any one of Aspects 13 to 18, the insertion portion includes multiple aligners including a first aligner in contact with a first end of the sheet inserted in the insertion portion, and a second aligner, in contact with a second end adjacent to the first end of the sheet inserted in the insertion portion. The first aligner and the second aligner is movable with respect to the sheet processing device.

### Aspect 20

In Aspect 20, the sheet processing apparatus according to any one of Aspects 13 to 19 further includes circuitry to control the sheet processing device to contact the sheet to execute the predetermined operation, and control the position marker to form the mark on the sheet.

### Aspect 21

In Aspect 21, an image forming apparatus includes an image forming device, a sheet stacker, and the sheet processing apparatus according to any one of Aspects 13 to 20. The image forming device forms an image on a sheet. The sheet stacker is a member to which the sheet having the image is ejected. The sheet processing apparatus performs a predetermined operation onto the sheet having the image while contacting the sheet. The sheet processing apparatus includes a sheet processing device, and moves between a first position at which the predetermined operation is performed on the sheet ejected to the sheet stacker and a second position at which the predetermined operation is performed on the sheet having the image before the sheet is ejected to the sheet stacker.

### Aspect 22

In Aspect 22, in the image forming apparatus according to Aspect 21, the sheet processing device includes a first processing unit and a second processing unit. The first processing unit performs the predetermined operation on the sheet ejected to the sheet stacker. The second processing unit is a unit at which the predetermined operation is performed on the sheet having the image before the sheet is ejected to the sheet stacker.

### Aspect 23

In Aspect 23, the image forming apparatus according to Aspect 21 or Aspect 22 further includes circuitry to execute at least one of a manual processing mode to perform the predetermined operation on the sheet processing apparatus, or an automatic processing mode to perform the predetermined operation on the sheet processing device.

### Aspect 24

In Aspect 24, an image forming system includes an image forming apparatus to form an image on a sheet, and the sheet processing apparatus according to any one of Aspects 13 to 20 coupled to the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A sheet processing apparatus comprising:
an insertion portion having an opening into which a sheet is insertable;
a sheet processing device to perform a predetermined operation onto the sheet inserted into the insertion portion; and
a position marker to form a mark at a processing position at which the predetermined operation is to be performed onto the sheet.

2. The sheet processing apparatus according to claim 1,
wherein the position marker the position marker deforms a part of the sheet to form the mark on the sheet.

3. The sheet processing apparatus according to claim 2,
wherein the position marker has a projection to contact and deform the part of the sheet inserted to the insertion portion to form the mark on the sheet.

4. The sheet processing apparatus according to claim 1,
wherein the position marker is disposed closer to the sheet than the sheet processing device in a state before the sheet processing device performs the predetermined operation onto the sheet, and
the position marker contacts the sheet before the sheet processing device contacts the sheet.

5. The sheet processing apparatus according to claim 4,
wherein the sheet processing device contacts the sheet while the position marker contacts the sheet.

6. The sheet processing apparatus according to claim 1,
wherein the position marker has markers on both sides of the sheet processing device.

7. The sheet processing apparatus according to claim 1,
wherein the insertion portion includes multiple aligners including:
a first aligner in contact with a first end of the sheet inserted in the insertion portion; and
a second aligner, in contact with a second end adjacent to the first end of the sheet inserted in the insertion portion, and
the first aligner and the second aligner is movable with respect to the sheet processing device.

8. The sheet processing apparatus according to claim 1, further comprising circuitry configured to:
control the sheet processing device to contact the sheet to execute the predetermined operation; and
control the position marker to form the mark on the sheet.

9. An image forming apparatus comprising:
an image forming device to form an image on a sheet;
a sheet stacker to which the sheet having the image is ejected; and
the sheet processing apparatus according to claim 1 to perform a predetermined operation onto the sheet having the image while contacting the sheet,
wherein the sheet processing apparatus includes a sheet processing device, and
the sheet processing apparatus moves between:
a first position at which the predetermined operation is performed on the sheet ejected to the sheet stacker; and
a second position at which the predetermined operation is performed on the sheet having the image before the sheet is ejected to the sheet stacker.

10. The image forming apparatus according to claim 9,
wherein the sheet processing device includes:
a first processing unit to perform the predetermined operation on the sheet ejected to the sheet stacker; and
a second processing unit at which the predetermined operation is performed on the sheet having the image before the sheet is ejected to the sheet stacker.

11. The image forming apparatus according to claim 9, further comprising circuitry configured to execute at least one of:
a manual processing mode to perform the predetermined operation on the sheet processing apparatus; and
an automatic processing mode to perform the predetermined operation on the sheet processing device.

12. An image forming system comprising:
an image forming apparatus to form an image on a sheet; and
the sheet processing apparatus according to claim 1 coupled to the image forming apparatus.
